(19) United States
(12) Patent Application Publication
(10) Pub. No.: US 2014/0198666 A1
(43) Pub. Date: Jul. 17, 2014

(54) DATA TRANSFER METHOD AND NODE APPARATUS THAT USES THE SAME

(71) Applicant: FUJITSU LIMITED, Kawasaki-shi (JP)

(72) Inventors: Kenji Yamada, Onojou (JP); Tadashige IWAO, Kawasaki (JP); Katsuhiko Yamatsu, Fukuoka (JP); Syunsuke KOGA, Fukuoka (JP)

(73) Assignee: FUJITSU LIMITED, Kawasaki-shi (JP)

(21) Appl. No.: 14/215,586

(22) Filed: Mar. 17, 2014

Related U.S. Application Data
(63) Continuation of application No. PCT/JP2011/071403, filed on Sep. 20, 2011.

(51) Int. Cl. H04L 12/26; H04L 12/24

(52) U.S. Cl. CPC H04L 43/0811; H04L 41/0686
USPC 370/244

(57) ABSTRACT

A node apparatus is provided that determines, according to the route stability indicator of the frame, whether to perform a process of judging whether the frame identification information to identify the frame is stored in a memory as the frame identification information, makes an update, only when a result of the judgment indicates a judgment is to be made on whether the frame identification information to identify the frame is stored in the memory as the frame identification information, the transmission possibility information stored in the memory such that the possibility of transmission to the node apparatus identified by the transmission-destination-node identification information indicates “not transmittable”, and selects, as a transmission-destination node apparatus, one adjacent node apparatus from the plurality of node apparatuses according to the transmission possibility information stored in the memory in association with the ultimate destination of the frame.

### CROSS-REFERENCE TO RELATED APPLICATION

This application is a continuation application of International Application PCT/JP2011/071403, filed on Sep. 20, 2011 and designated the U.S., the entire contents of which are incorporated herein by reference.

### FIELD

The embodiments discussed herein are related to a data communication method used in a network that includes a plurality of nodes and to a network apparatus that uses the same.

### BACKGROUND

In an ad-hoc network system, each ad-hoc network communication terminal (node apparatus, which may simply be called a node) autonomously establishes a network connection to other ad-hoc network communication terminals so that two-way communications can be established. The word “autonomously” means that a user does not need to establish a communication route on an as-needed basis and that a communication terminal or an infrastructure intended only for communication management of a server or a router is not needed.

Known routing protocols of an ad-hoc network (ad-hoc protocols) include the reactive Adhoc On Demand Distance Vector Algorithm (AODV) and the proactive Optimized Link State Routing (OLSR).

In the AODV, a communication node apparatus repeats broadcasts for a route search and finds a route to an objective node apparatus. A communication node apparatus sends a frame called a “Route Request (RREQ)” to a neighboring element in order to find a target route. The frame stores the communication node ID of a target to be detected.

When a neighboring communication apparatus is not searched for, this neighboring communication apparatus newly creates and repeatedly broadcasts an RREQ frame to neighboring elements. In this case, each communication node apparatus records information indicating which of the adjacent communication node apparatuses a message to the destination has been received from. When the RREQ message has reached the objective communication node, the objective communication node apparatus creates and transmits a “Route Reply (PREP)” frame to the source node through the route through which the RREQ frame has been transmitted. In this way, a bidirectional communication route is created.

In the OLSR, communication node apparatuses periodically exchange frames with each other so as to grasp the entirety of a network and detect a route to an objective communication node. The communication node apparatuses each periodically send a HELLO frame to report the presence thereof to the other communication node apparatuses. Recognizing the presence of a communications-partner communication node apparatus, a communication node apparatus generates a path for flooding called a Multi Point Relay (MPR) to efficiently deliver frames to the entirety of the network. The MPR allows frames to be efficiently broadcast from each communication node apparatus over the entirety of the network. Next, using the MPR, the node apparatuses each deliver a Technology Control (TC) frame, i.e., a route generation message, to the other node apparatuses so that all of the node apparatuses can realize a network topology. To send a frame to a target communication node apparatus, a source communication node apparatus references a network topology known by this source communication node apparatus and passes the frame to an appropriate adjacent communication node apparatus. The adjacent communication node performs processing in a similar way, and the frame is eventually delivered to the target node apparatus.

In a network system based on the premise that each node apparatus within a network grasps a network topology as described above, the system may be unable to follow a dynamic change in the network environment. For example, transmission does not necessarily succeed even when a node apparatus attempts to transmit data according to a network topology recognized at that time by this node apparatus.

In an ad-hoc network system in which each node apparatus autonomously operates, in the relaying of a transmitted frame addressed to a certain node apparatus, each node apparatus grasps a route that is effective at that time. Hence, each node apparatus includes tables to store various pieces of information referenced in the transmitting of a frame. The tables include an adjacent-node management table to record another node adjacent to the node apparatus, an FID (Frame IDentification) management table that manages identification information to uniquely identify each of the plurality of frames transmitted by a node apparatus that is the source of the frames (also called “GS” (Global Source)), and a weighting table that manages information to determine which adjacent node a frame is to be transmitted to in the transmitting of the frame to a destination node apparatus (also called a “GD (Global Destination)”).
Patent document 1: International Publication Pamphlet No. WO 2011/013165
Patent document 2: Japanese Laid-open Patent Publication No. 2008-166929

### SUMMARY

An example of a disclosed node apparatus includes: a receiver that receives a frame that includes a route stability indicator from one adjacent node apparatus of a plurality of node apparatuses that constitute a network; a memory that stores, in association with each other, frame identification information to identify the frame, transmission-destination-node identification information to identify an adjacent node apparatus from among the adjacent node apparatuses to which the frame is to be transferred, and origin-node identification information to identify a node apparatus that is a first to have transmitted the frame, and stores transmission possibility information indicating a possibility of transmission to each of the adjacent node apparatuses when an ultimate destination is given, the ultimate destination identifying a node apparatus from among the plurality of node apparatuses to which the frame is to be ultimately delivered; a processor that determines, according to the route stability indicator of the frame, whether to perform a process of judging whether the frame identification information to identify the frame is stored in a memory as the frame identification information, makes an update the transmission possibility information stored in the memory such that the possibility of transmission to the node apparatus identified by the transmission-destination-node identification information indicates “not transmittable” only when the process of judging whether the frame identification information to identify the frame is stored in the memory as the frame identification information is to be performed and the frame identification information to identify the frame is stored in the memory as the frame identification information, and selects, as a transmission-destination node apparatus, one adjacent node apparatus from the plurality of node apparatuses according to the transmission possibility information stored in the memory in association with the ultimate destination of the frame; and a transmitter that transmits the frame to the transmission-destination node apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an ad-hoc network configuration.

FIG. 2 illustrates exemplary functional blocks of a node apparatus.

FIG. 3 illustrates an exemplary hardware configuration of a node apparatus.

FIG. 4 illustrates a process for route selection at one node apparatus.

FIG. 5 illustrates a situation in which a route is selected in the ad-hoc network illustrated in FIG. 1.

FIG. 6 illustrates a situation in which a loop is sensed in the network illustrated in FIG. 1.

FIG. 7 illustrates a situation in which a route is changed in response to the sensing of a loop in the network illustrated in FIG. 1.

FIG. 8 illustrates an exemplary format of a data frame.

FIG. 9 illustrates an exemplary format of a hello frame.

FIG. 10 illustrates an exemplary format of an ACK frame.

FIG. 11 illustrates an example of a weighting table.

FIG. 12 illustrates an example of data stored in a buffer.

FIG. 13 illustrates an example of an adjacent-node management table depicted in FIG. 2.

FIG. 14A illustrates an example of an FID management table depicted in FIG. 2.

FIG. 14B illustrates another example of the FID management table depicted in FIG. 2.

FIG. 15 illustrates an outline of a process of transmitting a data frame at a global-source (GS) node apparatus.

FIG. 16 illustrates an outline of a process performed after a node apparatus in accordance with an embodiment receives a data frame.

FIG. 17 illustrates an exemplary network.

FIG. 18A is a flowchart illustrating a process performed after a node apparatus in accordance with an embodiment receives a data frame (pattern 1).

FIG. 18B is a flowchart illustrating a process performed after a node apparatus in accordance with an embodiment receives a data frame (pattern 2).

FIG. 18C is a flowchart illustrating a process performed after a node apparatus in accordance with an embodiment receives a data frame (pattern 3).

FIG. 19 illustrates a situation in which a data frame is transferred when a fault has not occurred in a link in a network that consists of node apparatuses in accordance with an embodiment.

FIG. 20 illustrates a situation in which a data frame is transferred when a fault has occurred in a certain link in a network that consists of node apparatuses in accordance with an embodiment.

FIG. 21 illustrates another exemplary format of a data frame.

FIG. 22A is a flowchart illustrating a process performed after a node apparatus in accordance with a comparative example receives a data frame (pattern 1).

FIG. 22B is a flowchart illustrating a process performed after a node apparatus in accordance with a comparative example receives a data frame (pattern 2).

FIG. 23 illustrates an outline of a process performed after a node apparatus in accordance with a comparative example receives a data frame.

FIG. 24 illustrates a plot of the throughput of a network that consists of node apparatuses in accordance with an embodiment relative to hop count.

### DESCRIPTION OF EMBODIMENTS

In an ad-hoc network, a large data communication traffic volume has led to a problem wherein the FID management tables of relay nodes are enlarged, thereby suppressing the resource. There has been another problem wherein the processes of searching, registering, and deleting an FID management table increase the period of time during which each node apparatus uses the CPU resource. There has been a still other problem wherein an increase in the number of hops, which indicates the number of times data is transferred by relay nodes, affects data throughput.

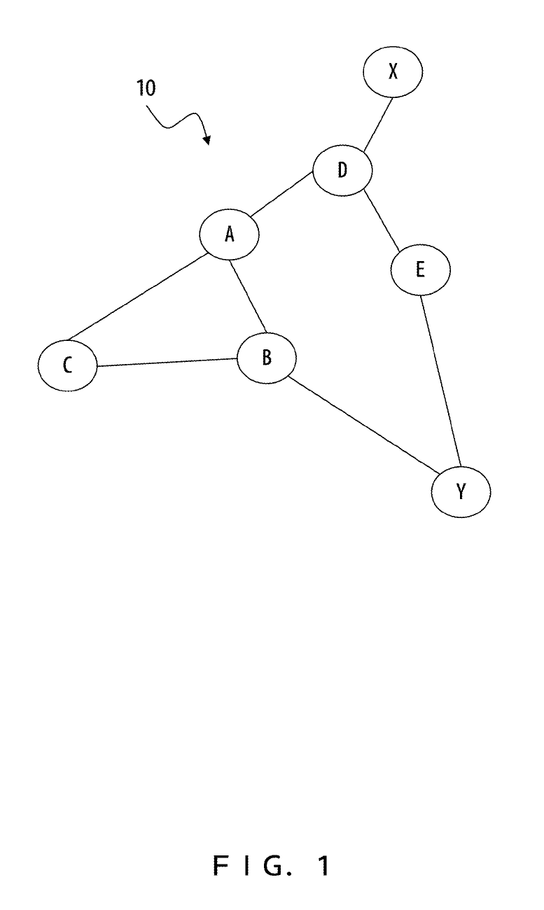

With reference to FIGS. 1-20, descriptions will be given of a data communication method used in a network and of a network apparatus that uses the same. The embodiment provides a method of optimizing a data transfer throughput and the resources of a memory and a CPU while grasping an effective route using an FID management table. The aforementioned node apparatus allows a data transfer throughput and the resources of a memory and a CPU to be optimized while using a route selection method that relies on an existing loop-sensing technique.

In the route selection method, a node that is the source of a data frame (hereinafter referred to as a “GS”) first writes the identification ID (also called a node ID) of this node and a Frame IDentification (FID) managed by this node in a data frame and transmits this data frame. Writing the node ID of the node apparatus that is the GS of the data frame and the FID in the frame allows individual frames to be identified. Next, when a node that transfers the data frame searches the FID management table of this node and finds no registration, the node determines that the data frame has been received for the first time, records the node from which the data frame has been received (also called an “LS” (Local Source)), selects and records a node that is different from the recorded node, and then performs transfer. When the node searches the FID management table of this node and does find registration, the node judges that a node that previously performed transfer did not arrive due to a loop, disables a recorded node, similarly records another transfer destination node, if any, and performs transfer, and, when another transfer destination node is not present, backtracking is performed to a node that is the first to have received the data. In this way, each node transfers data to a different route by detecting a loop and causes data to backtrack, thereby learning an optimum route for each data address.

A data frame transferred within a network in accordance with the embodiment includes a loop sensing flag introduced to improve a data transfer throughput and the resources of a memory and a CPU by omitting a process for loop sensing when the data frame is transferred through a stabilized route, i.e., a route that a node apparatus on the route has judged to not have a loop.

The loop sensing flag is, in particular, a value of “0” or “1”. The default value of the loop sensing flag is “1”. That is, a node apparatus in an initial state performs a process for loop sensing. As long as the loop sensing flag can supply information that allows a judgment to be made on whether a data frame is to be transferred through a stabilized route, the loop sensing flag may be, of course, a value that is different from “0” and “1”. The value of the loop sensing flag is also called a “route stability indicator”.

FIG. 1 illustrates an example of an ad-hoc network configuration. A network 10 in FIG. 1, which is an example of an ad-hoc network to which the following embodiment is applicable, includes seven node apparatuses X, Y, A, B, C, D, and E. Each node apparatus may simply be called a “node” in terms of a network topology.

One or more node apparatuses within the network 10 may be connected to an apparatus that belongs to another network. For example, one of the node apparatuses that belong to the network 10 may be connected to a gateway apparatus of an external network that includes a data management server. Data transmitted and received by the node apparatus may be transmitted via the gateway apparatus to the external data management server, which manages this transmitted data.

Each node apparatus that constitutes the network 10 has assigned thereto an identification information e.g., “node ID (IDentification)”. Note that the reference marks assigned to the nodes in FIG. 1 indicate node IDs. From the perspective of each node apparatus, the node ID assigned to the node apparatus itself is also called an “own node ID”.

In FIG. 1, a link is present between node apparatuses that can directly communicate with each other. The links are indicated by solid lines. In particular, links are present between the node apparatuses X and D, the node apparatuses D and A, the node apparatuses D and E, the node apparatuses E and Y, the node apparatuses A and B, the node apparatuses A and C, the node apparatuses B and C, and the node apparatuses B and Y. The link may be a radio link that wirelessly connects node apparatuses or may be a cable link that connects node apparatuses in a cable manner.

Two node apparatuses separated from each other by one link but linked to each other by the link are adjacent to each other.

The topology of a network such as the ad-hoc network 10 is dynamic. “A topology is dynamic” means that the number of node apparatuses or the number of links is changeable. That is, any of the node apparatuses that constitute the network 10 may be removed, and a new node apparatus may be added. A certain link may suddenly disappear, and a new link may appear. The number of node apparatuses or the number of links may be intentionally changed by a network administrator or may be changed by another factor.

A frame is transmitted or received as a Protocol Data Unit (PDU) between node apparatuses of the network 10. When, for example, a certain frame is transmitted from the node apparatus X to the node apparatus Y, the node apparatus X is called a “GS (Global Source)” and the node apparatus Y is called a “GD (Global Destination)”. In FIG. 1, the routes from the node apparatus X to the node apparatus Y are, for example, the route passing through the node apparatuses D and E, the route passing through the node apparatuses D, A, and B, and the route passing through the node apparatuses D, A, C, and B. Those routes may be indicated as <X, D, E, Y>, <X, D, A, B, Y>, and <X, D, A, C, B, Y> using a tuple notation. As described above, the route <X, D, E, Y> indicates that the node apparatus X is a GS and that the node apparatus Y is a GD. When a frame is transmitted from the node apparatus X to the node apparatus D and is received by the node apparatus D, the node apparatus X is called an “LS (Local Source)” and the node apparatus D is called an “LD (Local Destination)”. An LS and an LD are defined for two node apparatuses separated by one link.

The number of links on a route is also called a “hop count (number of hops)”. As an example, in the route <X, D, E, Y>, the number of hops between the node X, a GS, and the node Y, a GD, is three. The number of hops between an LS and an LD is one in accordance with the definition.

A certain node apparatus within the ad-hoc network 10 illustrated in FIG. 1 recognizes the presence and the node ID of an adjacent node apparatus. As an example, the node apparatus A recognizes the three adjacent node apparatuses and the node IDs, i.e., B, C, and D, and does not need to grasp the entirety of the network 10. In other words, a certain node apparatus holds only information related to a node apparatus and a link belonging to the range within a hop count of 1. Information held by a certain node apparatus also includes information related to this certain node apparatus. Thus, increasing the scale of the network 10 does not cause the node apparatuses to perform data communications to recognize the entirety of the network, which would apply a great load to the network, and hence the performance of the entirety of the network system does not deteriorate.

A data frame transmitted or received within the network 10 includes frame identification information to uniquely identify the data frame. An example of the frame identification information is the combination of the node ID of a node apparatus that is the GS of a data frame, and an FID (Frame IDentification), which is information to identify a frame transmitted by each node apparatus that is a GS. Examples of the FIDs include a sequence number of a predetermined bit count and a time stamp. Using, for example, the time stamp as an FID may cause a plurality of nodes to generate the same FIDs. However, since frame identification information is the combination of an FID and the node ID of a node apparatus that is the GS of a data frame, data frames transmitted by different node apparatuses that are GSs each have a different piece of frame identification information.

As described above, the data frame in accordance with the embodiment includes a node sensing flag.

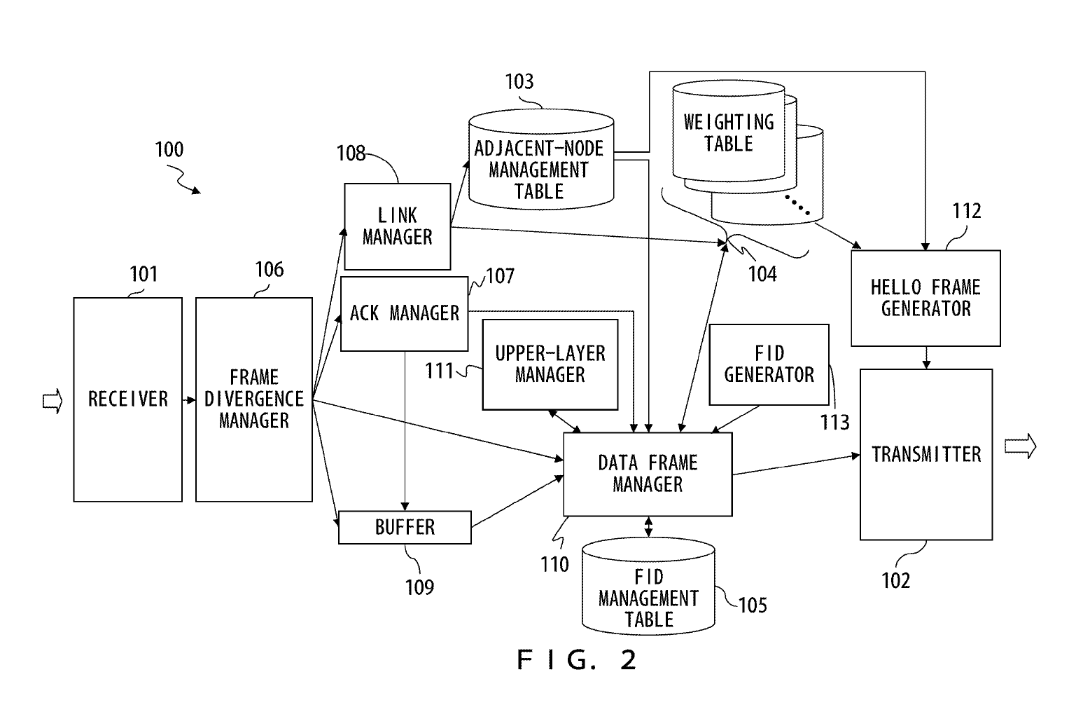

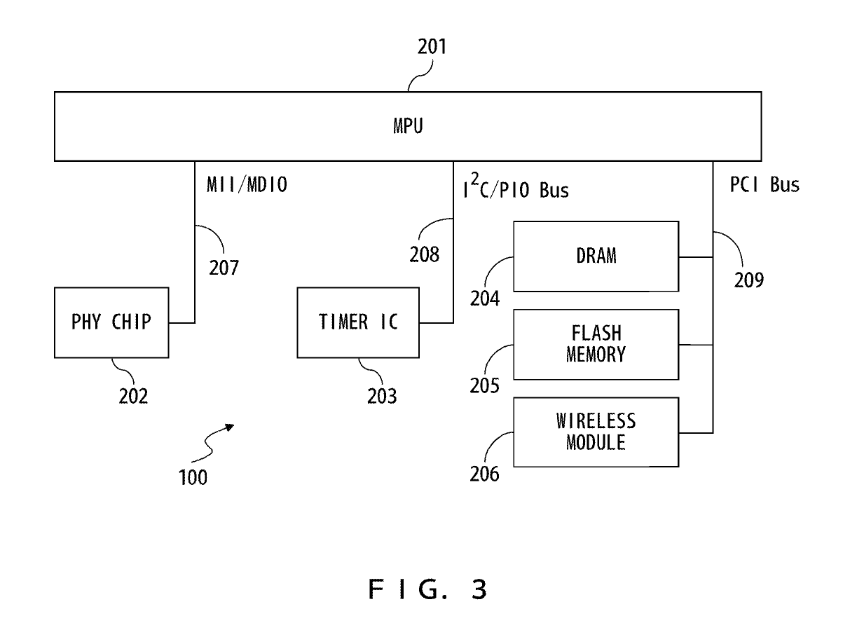

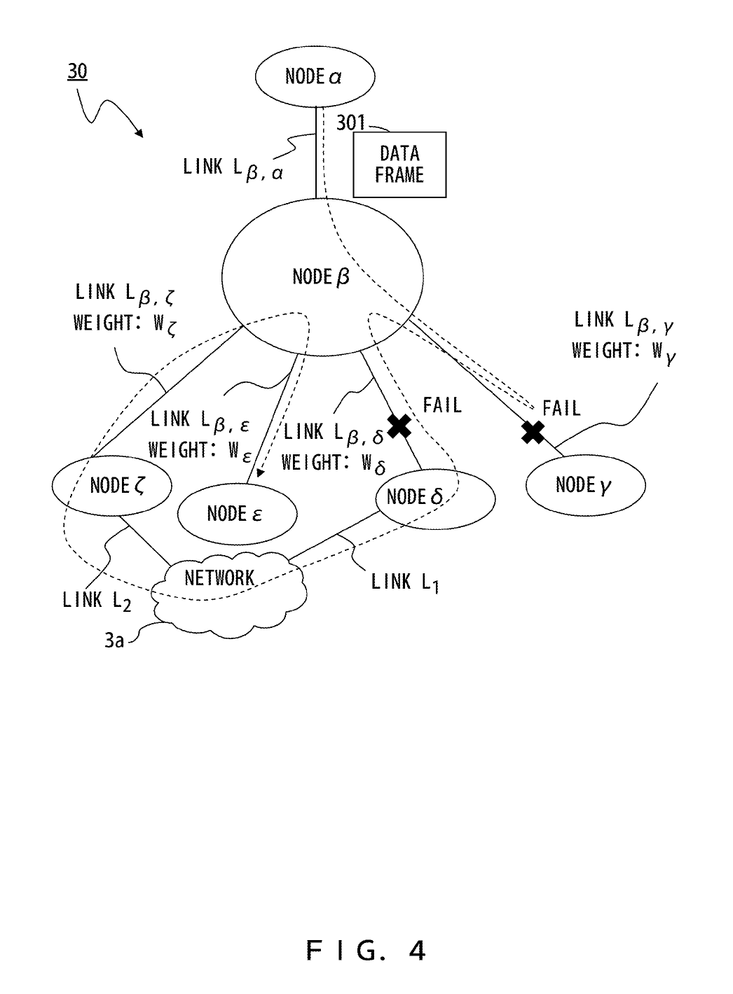

FIG. 2 illustrates exemplary functional blocks of anode apparatus, and FIG. 3 illustrates an exemplary hardware configuration of a node apparatus. FIG. 4 illustrates a process for route selection at a node apparatus having such a configuration.

As illustrated in FIG. 2, a node apparatus 100 that constitutes the ad-hoc network 10 includes a receiver 101 and a transmitter 102 that transmits a frame.

The node apparatus 100 includes tables to store various pieces of information referenced in the transmitting of a frame. The tables include an adjacent-node management table 103 to record another node adjacent to the node apparatus, a weighting table 104 that manages information to determine which adjacent node a frame is to be transmitted to in the transmitting of the frame to a destination node apparatus (also called a “GD (Global Destination)”), and an FID (Frame IDentification) management table 105 that manages identification information to uniquely identify each of the plurality of frames transmitted by a node apparatus that is the source of the frames (also referred to as a “GS” (Global Source)). The FID management table 105 is an example of the storage. The storage(s) may be constructed by a memory.

The weighting table 104 is a table to manage, for each GD, information to determine which adjacent node apparatus a frame is to be transmitted to The node apparatus 100 depicted in FIG. 2 is used in the network 10 that consists of seven node apparatuses, and hence each node apparatus has at most six adjacent nodes. Thus, the weighting tables 104 of a node apparatus i (i=1 to 6) include a weighting table 104i-j (j=1 to max6) for each adjacent node. In accordance with information included in the weighting table 104, a determination may be made as to which adjacent node is to be selected as an LD for a frame addressed to a GD. That is, the “weight” in this example indicates, for each GD of a frame, a priority in the selecting of an LD in relation to one or more node apparatuses adjacent to the node apparatus 100. The weighting table 104 is also an example of the storage.

The node apparatus 100 further includes a frame divergence manager 106 that determines a type of a frame received by the receiver 100. The frames include, for example, a data frame, a hello frame, and an ACK (ACKnowledge) frame.

A data frame includes, as a payload, data that a GS node apparatus attempts to convey to a GD node apparatus. That is, a data frame includes, as a payload, a PDU of a protocol defined by a layer ordered higher than a layer by which a frame is defined.

A hello frame, i.e., a type of control frame to communicate control information, is a frame used by the node apparatus 100 to report the presence thereof to another node apparatus. Upon receipt of a hello frame, a node apparatus stores, in the adjacent-node management table 103 thereof, information related to the presence of the node apparatus that is the source of the hello frame, updates the adjacent-node management table 103, and updates the weighting table 104.

An ACK frame is a frame that a certain node apparatus receives from an adjacent node apparatus when the certain node apparatus successfully transmits a data frame to the adjacent node apparatus. The fact that a node apparatus that has transmitted a data frame does not receive an ACK frame even after a predetermined time period has elapsed means that the transmission of the data frame has failed.

The node apparatus 100 includes managers to perform processes associated with the reception of frames. In particular, the node apparatus 100 includes an ACK manager 107 that performs a process related to an ACK frame and a link manager 108 that performs a process in association with the reception of a hello frame. The ACK manager 107 performs, for example, monitoring to determine whether an ACK frame is received within a predetermined time period after transmission of a data frame. The link manager 108 manages the adjacent-node management table and also relates to the management of the weighting table 104. The link manager 108 newly adds an adjacent node to the adjacent-node management table 103 and performs an aging process of deleting an entry related to a node apparatus that has become unrecognizable. The link manager 108 performs addition, deletion, or updating related to an adjacent node apparatus for the weighting table 104. In addition, a buffer 109 and a data frame manager 110 are provided to perform a process in association with reception of a data frame. Moreover, an upper-layer manager 111, a hello frame generator 112, and an FID (Frame IDentification) generator 113 are provided.

When the node apparatus 100 is a GS or a GD, the upper-layer manager 111 processes a PDU of an upper layer included as a payload in a data frame.

When the node apparatus 100 receives a frame, above mentioned units are operated as follows.

Upon receipt of a frame, the receiver 101 of the node apparatus 100 sends the received frame to the frame divergence manager 106. The frame divergence manager 106 determines the type of the frame. The frame divergence manager 106 determines, for example, which of a data frame, a hello frame, or an ACK (ACKnowledge) frame the received frame is.

Upon receipt of a hello frame, the frame divergence manager 106 outputs the received hello frame to the link manager 108. Upon receipt of the hello frame, the link manager 108 recognizes the presence of an adjacent node and reflects the recognition result in the adjacent-node management table 103. When a change is made in the adjacent-node management table 103, the link manager 108 may update the weighting table 104.

When the receiver 101 of the node apparatus 100 receives an ACK frame, the frame divergence manager 106 outputs the received ACK frame to the ACK manager 107.

The buffer 109 stores a data frame so as to prepare for a failure of transmission of the data frame and to retransmit the data frame.

In response to reception of an ACK frame, the ACK manager 107 recognizes the completion of transmission of a data frame and deletes the data frame that has become unnecessary from the buffer 109. The ACK manager 107 reports to the data frame manager 110 whether transmission of a data frame has succeeded.

When the receiver 101 of the node apparatus 100 receives a data frame, the frame divergence manager 106 stores the received data frame in the buffer 109 and also transmits this data frame to the data frame manager 110.

The data frame manager 110, which has received the data frame from the frame divergence manager 106, performs, for example, the following processes.

One process performed by the data frame manager 110 is generating an ACK frame associated with the data frame received by the receiver 101 and instructing the transmitter 102 to transmit the ACK frame.

The data frame manager 110 judges whether the GD of the received data frame is equal to the own node ID of the node apparatus 100. When the GD of the received data frame is different from the own node ID of the node apparatus 100, the data frame manager 110 references the FID management table 105 to judge whether the data frame received at that time is a data frame that has returned to the node apparatus 100 through a route in the network 10 where the frame is looped (hereinafter simply referred to as a “loop route”). “A frame is looped” means that a frame that was received in the past by a node apparatus 100 that is an LS returns to the node apparatus 100 after being relayed within the network 10.

When the data frame received at that time is judged to not be a data frame transmitted via the aforementioned loop route, the data frame manager 110 selects an adjacent node apparatus as an LD in order to transfer the received data frame, and gives the transmitter 102 an instruction to transfer the data frame.

When the data frame received at that time is judged to be a data frame transmitted via the aforementioned loop route, the data frame manager 110 recognizes that an adjacent node apparatus that was selected as an LD in the past was not an appropriate LD and reflects a result of the recognition in the weighting table 104. The data frame manager 110 then references the weighting table 104 to judge whether an adjacent node apparatus selectable as an LD is still present.

Upon receipt of a report from the ACK manager 107 indicating whether a data frame has been successfully transmitted, the data frame manager 110 judges whether a node apparatus that has been selected as an LD of the data frame is an appropriate LD and reflects a result of the judgment in the weighting table 104.

The link manager 108 and the data frame manager 110 of the node apparatus 100 determine and perform a process that depends on the value of a loop sensing flag (route stability indicator). The combination of these units may be referred to as route-stability-indicator manager.

The node apparatus 100 also performs the following process.

The hello frame generator 112 uses the weighting table 104 and the adjacent-node management table 103 to periodically generate and send a hello frame to the transmitter 102. Upon receipt of the hello frame from the hello frame generator 112, the transmitter 102 transmits the hello frame to an adjacent node.

At an arbitrary timing, the upper-layer manager 111 sends, to the data frame manager 110, data to be incorporated as a payload into a data frame. Receiving the data, the data frame manager 110 creates a data frame at a request of the upper-layer manager 111 and sends the data frame to the transmitter 102. Receiving the data frame from the data frame manager 110, the transmitter 102 transmits the data frame to an adjacent node apparatus that is an LD. The GS of such a data frame is undoubtedly the node apparatus 100.

FIG. 3 illustrates an exemplary hardware configuration of the node apparatus 100 having the aforementioned functions.

In FIG. 3, the node apparatus 100 includes a microprocessing unit (MPU) 201, a physical layer (PHY) chip 202, a timer IC (Integrated Circuit) 203, a dynamic random access memory (DRAM) 204, a flash memory 205, and a wireless module 206. The MPU 201 may be referred to as a processor.

A communication interface connecting the MPU 201 and the PHY chip 202 is an MII/MDIO (Media Independent Interface or Management Data Input/Output) 207. MII and MDIO are both interface standards that manage a communication between a physical layer and a MAC sublayer (Media Access Control sublayer). The MPU 201 and the timer IC are connected via an I²C/PIO (Inter-Integrated Circuit or Parallel Input/Output) bus 208. The DRAM 204, the flash memory 205, and the wireless module 206 are connected to the MPU 201 via a PCI (Peripheral Component Interconnect) bus 209.

The MPU 201 loads into the DRAM 204 a program such as firmware stored in the flash memory 205 and performs a process using the DRAM 204 as a working memory. To install the program into the node apparatus 100, the program may be stored in a computer-readable record medium instead of the flash memory 205 or may be downloaded from a network such as the Internet via the PHY chip 202 or the wireless module 206. In addition to the memories such as the DRAM 204 and the flash memory 205, a storage apparatus such as an SRAM (Static Random Access Memory) or an SDRAM (Synchronous Random Access Memory) may be provided. The program may be stored in a nonvolatile storage apparatus (not illustrated), e.g., a hard disk drive. The MPU 201 can execute the program to be operated as the frame divergence manager 106, the ACK manager 107, the link manager 108, the data frame manager 110, the upper-layer manager 111, the hello frame generator 112, and the FID generator 113, all illustrated in FIG. 2.

The DRAM 204, the flash memory 205, or a storage apparatus (not illustrated) implements the adjacent-node management table 103, the weighting table 104, the FID management table 105, and the buffer 109.

The flash memory 205 not only stores a program for the processes by the MPU 201 but also information specific to the node apparatus 100, such as the node ID of the node apparatus 100.

The PHY chip 202 is a device that performs a process for the physical layer of a wired connection. When the ad-hoc network 10 that includes the node apparatus 100 is a wireless network, the PHY chip 202 may be omitted. When the ad-hoc network 10 is a wired network, the node apparatus 100 may include a LAN port that follows the Ethernet® standard and may be connected to an external apparatus such as a gateway apparatus via a cable connected to the LAN port.

When the ad-hoc network 10 is a wired network, the MPU 201 generates and outputs an Ethernet frame to the PHY chip 202 via the MII/MDOI 207. The PHY chip 202 may convert information related to the Ethernet frame from the MPU 201 into a signal that depends on the type of a cable and may output the signal from a LAN port (not illustrated) to outside the node apparatus 100. The PHY chip 202 may convert a signal input to the node apparatus 100 from outside the node apparatus 100 via a cable and a LAN port into a signal that the MPU 201 can recognize via the MII/MDOI 207 and may output the signal to the MPU 201.

When, for example, the ad-hoc network 10 is a wireless network, the wireless module 208 performs a process for the physical layer of wireless connection. The receiver 101 and the transmitter 102 in FIG. 2 are implemented by a wireless module. The wireless module 208 may include, for example, an antenna, converters such as an AD converter and a DA converter, a modulator, a demodulator, and an amplifier.

The timer IC 203 measures off time until a time period that has been set elapses, and, after the time period that has been set elapses, the timer IC 203 outputs an interrupt signal. The timer IC 203 may output, for example, an interrupt signal to perform respective aging processes on the adjacent-node management table 103, the weighting table 104, and the FID management table 105 at predetermined time intervals.

The receiver 101, the frame divergence manager 106, the link manager 108, and the hello frame generator 112 are included in route information obtainer that obtains information related to a route through transmission and reception of a hello frame.

The hardware configuration of the node apparatus 100 having the aforementioned functions is not limited to the one illustrated in FIG. 3. Various variations are possible. Some of or all of the frame divergence manager 106, the ACK manager 107, the link manager 108, the data frame manager 110, the upper-layer manager 111, the hello frame generator 112, and the FID generator 113, all depicted in FIG. 2, may be configured as, for example, dedicated circuits.

<Detection of Loop>

The following will describe a process for route selection at each node apparatus.

FIG. 4 illustrates a process for route selection at one node apparatus. In a network 30 illustrated in FIG. 4, a node apparatus β is connected to the five adjacent node apparatuses, nodes α, γ, δ, ε, and ζ via links. That is, the node apparatus β has extended therefrom the five links: a link L_{α,β} between the nodes β and α, a link _{β,γ} between the nodes β and γ, a link L_{β,ζ} between the nodes β and δ, a link L_{β,ε} between the nodes β and ε, and a link L_{β,ζ} between the nodes β and ζ.

The nodes δ and ζ are connected directly or indirectly to each other via a link L₁, a network 3a, and a link L₂. That is, the network 3a may be a contact point between the links L₁ and L₂.

In FIG. 4, the node β receives from the node α a data frame 301 whose GD is a node η (not illustrated in FIG. 4). Data frames from the node β can reach the node η via any of the nodes γ, δ, ε, and ζ.

The node apparatus β includes the weighting table 104. A weighting table for the node η may hereinafter be referred to as a “table 104-η”. In the weighting table 104-η, weights W_{α}, W_{γ}, W_{δ}, W_{ε}, and W_{ζ} are respectively assigned to the five adjacent node apparatuses, the nodes α, γ, δ, ε, and ζ.

When the node apparatuses wirelessly communicate with each other, an environment and a distance between node apparatuses during a communication may affect communication quality; when the node apparatuses perform cable communications, an element, e.g., a traffic volume, may affect communication quality. In this example, in consideration of such influences, the weight range is from 0 to 1. Of course, the weights are not limited to this range, and, in an embodiment, a value that is not within the range may be used as a weight. This example is based on the assumption that higher priority is given to a node with a weight of a lower value.

Assume that, at a moment when the node β receives the data frame 301 from the node a, the weights W_{γ}, W_{δ}, W_{ε}, and W_{ζ} satisfy a magnitude relationship of <W_{γ}<W_{δ}<W_{ε}<W_{ζ}. That is, from the perspective of the node β, the highest priority is given to the node γ from among the four adjacent nodes γ, δ, ε, and ζ. Thus, the node β first selects the node γ as an LD for transfer of the data frame 301 and transmits the data frame 301 to the node γ.

When the transmission to the node γ fails, the node β increases the value of the weight W_{γ} and recognizes that selecting the node γ as an LD is inappropriate in the transmitting of a data frame whose GD is the node η.

The failure of transmission includes the following. (F1) Due to a fault in the link L_{β,γ}, the data frame 301 from the node β does not reach the node γ.

(F2) Due to a fault in the node γ, the node γ cannot receive the data frame 301.

(F3) The data frame 301 returns from the node γ to the node β.

(F1) corresponds to a situation in which a fault occurs in the link L_{β,γ} at the moment when the node β transfers the data frame 301 to the node γ, thereby disabling the data frame 301 from reaching the node γ. (F2) corresponds to a situation in which, although a fault is not present in the link L_{β,γ}, the node γ cannot receive the data frame 301 due to a fault that has occurred in the function of the node γ. In (F1) and (F2), the node apparatus β recognizes a transmission failure in response to the fact that an ACK frame for the data frame 301 is not responsively sent from the node γ to the node β within a predetermined time period. In the embodiment, when (F1) or (F2) occurs, a predetermined value is added to the value of the weight W_{γ}.

In (F3), the transmission of the data frame 301 from the node β to the node γ succeeds after a fashion. This can be verified according to the fact that an ACK frame for the data frame 301 is responsively sent from the node γ to the node β within a predetermined time period. In this case, the node β may decrease the value of the weight W_{γ} for the data frame 301 from the weight node γ to the node β corresponding to the node γ selected as an LD.

In (F3), however, the node γ returns the data frame 301 to the node β when a route is not found through which the data frame 301 can be transferred from the node γ to the node η, the GD. This is called a backtrack operation.

When the node γ performs the backtrack operation, the node β receives from the node γ the data frame 301 that the node β itself transmitted to the node γ in the past. Accordingly, the node β recognizes that selecting the node γ as an LD is inappropriate when the node β transmits the data frame 301 whose GD is the node η. In the embodiment, when (F3) occurs, the value of the weight W_{γ} is set to the highest value.

The following descriptions will be based on FIG. 4 again. Assume that the node β transmits the data frame 301 to the node γ and then recognizes a transmission failure, thereby changing the value of the weight W_{γ}. As a result, the magnitude relationship between the weights W_{γ}, W_{δ}, W_{ε}, and W_{ζ} is changed to W_{δ}<W_{ε}<W_{ζ}<W_{γ}.

Then, to deliver the data frame 301 to the node η, i.e., the GD, the node β selects as an LD a node that is different from the node γ and attempts to retransmit the data frame 301. At that moment, the node δ has the highest priority. Hence, the node β selects the node δ as an LD and retransmits the data frame 301.

In this case, the following occurs in FIG. 4. The data frame 301 sent from the node β reaches the node δ. The node δ transmits an ACK frame for the data frame 301 to the node β. Upon receipt of the ACK frame from the node δ, the node β recognizes the success of the transmission of the data frame 301 to the node δ and decreases the value of the weight W_{ε}. Even after the value of the weight is changed, a magnitude relationship of W_{δ}<W_{ε}<W_{ζ}<W_{γ} is still satisfied. Assume that the data frame 301 that has reached the node δ reaches the node ζ via the network 3a and that the node ζ selects the node β as an LD. Accordingly, the node β receives from the node ζ the data frame 301 that the node β transmitted in the past and recognizes a transmission failure. That is, the node β recognizes that selecting the node δ as an LD is inappropriate in the transmitting of the data frame 301 whose GD is the node η from the node β. This corresponds to a transmission failure wherein the data frame 301 returns to the node β due to the formation of a loop route of (F4)<β, δ, network 3a, ζ, β>.

In response to the occurrence of (F4), the node β increases the value of the weight W_{δ}. For example, the value of the weight W_{ε} is set to the highest value. The magnitude relationship between the weights W_{ζ}, W_{δ}, W_{ε}, and W_{ζ} becomes W_{ε}<W_{ζ}<W_{γ}=W_{δ}.

Next, with reference to the new magnitude relationship between the weights, the node β defines the node ε as an LD and transmits the data frame 301 whose GD is the node η. The example of FIG. 4 is based on the assumption that the transmission of the data frame 301 to the node ε succeeds. In accordance with the success of the transmission of the data frame 301 to the node ε, the node β decreases the value of the weight W_{ε} of the node ε, but the magnitude relationship between the weights W_{γ}, W_{δ}, W_{ε}, and W_{ζ} remains W_{ε}<W_{ζ}<W_{γ}=W_{δ}.

Changer makes such a change in a weight. The changer includes the data frame manager 110.

<Loop Sensing Process and Route Determining Method>

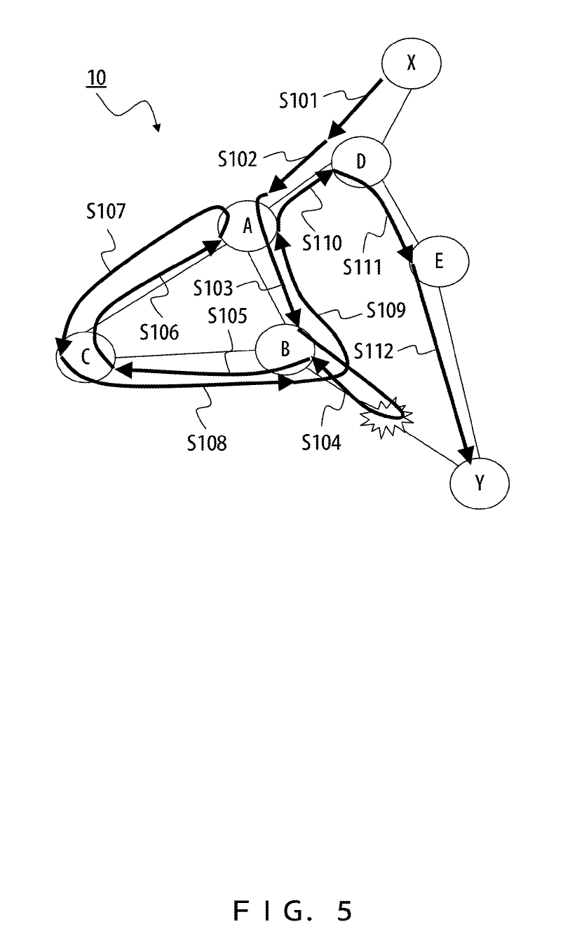

FIG. 5 illustrates a situation in which a route is selected while a loop sensing process is being performed in the ad-hoc network illustrated in FIG. 1. In FIG. 5, a route is dynamically selected in an autonomous-distributed manner. FIG. 5 depicts a situation in which a route is selected within the network 10 in the transmitting of a data frame whose GD is the node Y under a condition in which the node X is the GS. FIG. 5 illustrates the first data frame to be transmitted from X to Y. That is, when the loop sensing flag for each link within the network in FIG. 1 is “1”, i.e., when each node apparatus transmits or receives a data frame with “1” stored in the loop-sensing-flag field, the node apparatus performs a loop sensing process. Hence, FIG. 5 will not be described with reference to a process related to a loop sensing flag.

FIG. 5 will be described with reference to a weighting table 104-α at a node apparatus α (α=X, Y, A, B, C, D, E). The weight in the weighting table 104-α for the node β (β≠α=X, Y, A, B, C, D, E) will be indicated as W(α)_{β}. Strictly speaking, a weight is defined for each GD; accordingly, for the present case, a weight may be defined for the node β (β≠α=X, Y, A, B, C, D, E) for the transmission of a frame whose GD in the weighting table 104-α is the node γ, and such a weight will be indicated as W^{γ}(α)_{β} or W_{α,γ,β}. However, the descriptions of FIG. 5 relate to only the relaying of a data frame whose GD is a node Y, and hence the weight for the node β in the weighting table 104-α will be indicated as W(α)_{β}.

In step S101, the node X, a GS, selects the adjacent node D as an LD and transmits a data frame to the node D.

The two nodes A and E are adjacent to the node D. Assume that the weighting table 104-D indicates that the weights for the nodes A and E satisfy a magnitude relationship of W(D)_{A}<W(D)_{E}.

In step S102, the node D selects the node A as an LD for the transfer of the data frame received in step S101 and transmits the data frame to the node A.

Upon receipt of the data frame from the node D in step S102, the node A selects a next transfer destination. Assume that W(A)_{B}<W(A)_{C} is satisfied in the weighting table 104-A of the node A.

In step S103, the node A selects the node B as an LD for the transfer of the data frame received in step S102 and transmits the data frame to the node B.

Upon receipt of the data frame from the node A in step S103, the node B selects a next transfer destination. Assume that W(B)_{Y}<W(A)_{C} is satisfied in the weighting table 104-B of the node B.

In step S104, the node B selects the node Y as an LD for the transfer of the data frame received in step S103 and transmits the data frame to the node Y. Assume that, at this moment, the transmission to the node Y fails due to a fault in a link connecting the nodes B and Y. The failure of the transmission to the node Y is recognized when the node B does not receive an ACK frame from the node Y within a predetermined time period after the transmission. The situation is similar to the situation of the transmission failure in FIG. 4 that occurs in the transmission of a data frame from the node β to the node γ. Recognizing the failure of the transmission to the node Y, the node B updates the weighting table 104-B. As a result, W(B)_{C}<W(B)_{Y}.

In step S105, the node B transfers the data frame to the node C in accordance with the magnitude relationship between the weights W (B)_{C}<W (B)_{Y} in the updated weighting table 104-B.

In step S106, the node C transfers to the node A the data frame received from the node B in step S105. This is because the node A is the only destination to which the node C transfers the data frame from the node B.

Upon receipt of the data frame from the node C, the node A recognizes that the node A itself transmitted the data frame to the node B in the past. That is, a loop route of <A, B, C, A> has been formed. This situation is similar to the situation of FIG. 4 in which the node β receives from the node ζ a data frame that the node β itself transmitted to the node δ. Hence, the node A updates the weighting table 104-A in a manner such that the value of the weight of the node B for the node A becomes the highest value.

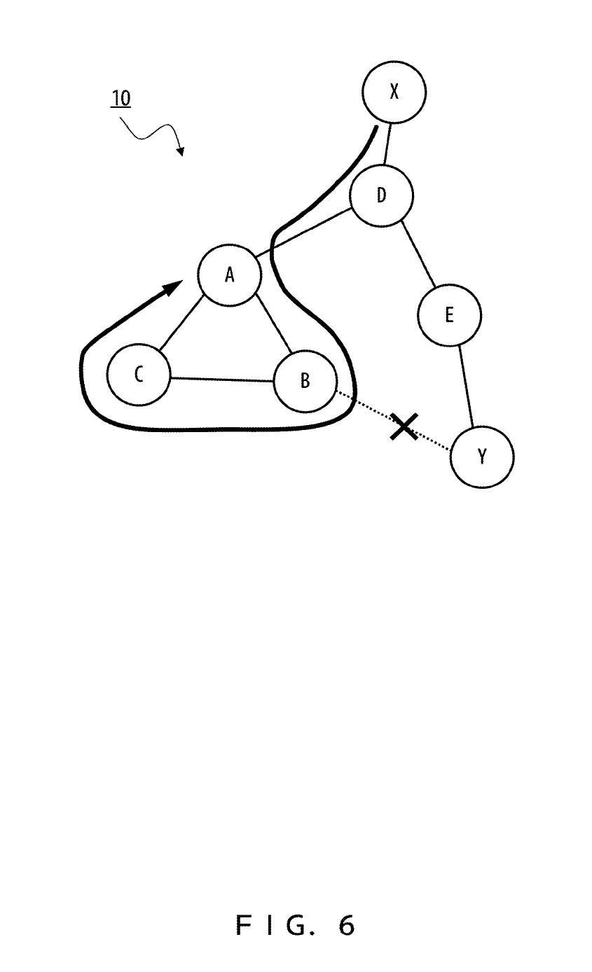

The route through which a data frame is transferred in steps S101-S106 is a route such as that depicted in FIG. 6. That is, in the transferring of data from the node X to the node Y, the node X transmits the data to the node D, and the node D transfers the data to the node A. The node A has received from the node C a frame the node A itself transferred to the node B (has sensed a loop) and thus learns that “transferring data to the node B is inappropriate in the transferring of the data to the node Y”.

In the following step, step S107, the node A makes the following determinations. In the selecting of a transfer destination of the data frame received from the node C in step S106, the data frame was originally received from the node D in step S102. The data frame was transmitted to the node B in the past, i.e., in step S103. Accordingly, for the node A, the node C is the only adjacent node that has not been employed as an LD. In step S107, the node A transmits to the node C the data frame received from the node C in step S106.

Upon receipt of the data frame from the node A, the node C recognizes that the node C itself transmitted the data frame to the node A in step S106. Thus, the node C updates the weighting table 104-C in a manner such that the value of the weight of the node A for the node C becomes the highest value.

In step S108, the node C makes a determination similar to the determination made by the node A in step S107, selects the node B as an LD, and transfers the data frame received from the node A in step S107. The transfer of a data frame from the node C to the node B defines a backtrack operation. In view of the backtrack operation by the node C, the node B recognizes that, in the relaying of a data frame whose GD is the node Y, the node C cannot transfer the data frame to another node.

In the following step, step S109, the node B makes a determination similar to the determination made by the node C in step S108 and returns the data frame to the node A. That is, upon receipt of the data frame from the node C, the node B recognizes that the node B itself transmitted the data frame to the node C in step S105. Thus, the node B updates the weighting table 104-B in a manner such that the value of the weight of the node C for the node B becomes the highest value. The node B also recognizes that the data frame was transmitted to the node Y in step S104 but the transmission ended in failure. Accordingly, for the node B, the node A is the only adjacent node that has not been employed as an LD. In step S109, the node B transmits to the node A the data frame received from the node C in step S108.

In step S110, the node A recognizes that the data frame received from the node B is a data frame that was received from the node D in step S102, was transmitted to the node B in step S103, was received from the node C in step S106, and was returned to the node C in step S107. Accordingly, the node A transfers to the node D the data frame received from the node B in step S109. That is, the backtrack operation is also performed in this step.

Upon receipt of the data frame from the node A, the node D updates the weighting table 104-D in a manner such that the value of the weight of the node A for the node D becomes the highest value.

In the following step, step S111, the node D selects the node E, i.e., an adjacent node that has not yet been used as an LD for the transfer of the data frame, and transfers the data frame to the node E.

For the node E, which has received the data frame from the node D, the node Y is the only LD candidate for the transfer of the data frame.

Accordingly, in step S112, the node E sends to the node Y the data frame received from the node D in step S111.

In this way, in the ad-hoc network 10, even when a fault occurs in the network 10, a data frame is delivered to a desired GD via each node being operated in an autonomous-distributed manner.

FIG. 6 illustrates a situation in which a loop route <A, B, C, A> is sensed in the network 10 via the aforementioned operation.

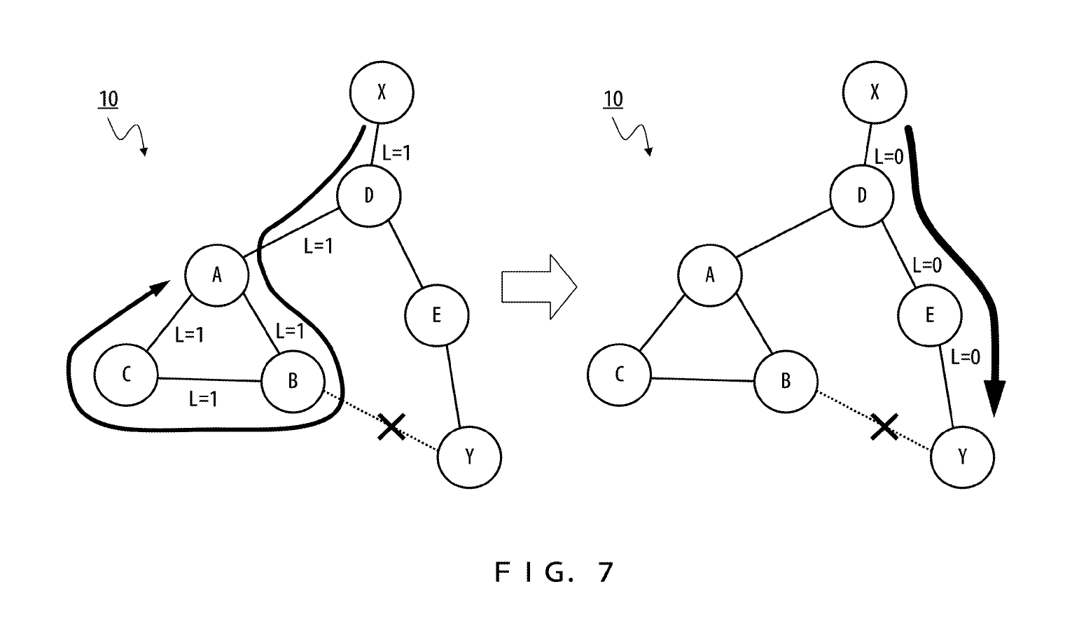

FIG. 7 illustrates a situation in which a route is changed as a result of the sensing of the loop route <A, B, C, A> in the network 10.

The left side of FIG. 7 depicts a state in which a link between the nodes B and Y is unstable and is sometimes disconnected. On the left side of FIG. 7, all of the values L of the loop sensing flags which are each assigned to a link are L=1. In this case, when a link is disconnected, a loop is detected at the node A, a loop is also detected after transfer to the node C, and a backtracking to the node D is performed. Since the data frame returns after being transferred to the node A, a loop is also sensed at the node D, and hence the node D also transfers the data frame to the node E on another route.

The right side of FIG. 7 depicts a situation in which a route <X, D, E, Y> has been formed as a result of a loop-route sensing process. The route is stabilized when links are robust between the nodes X and D, between the nodes D and E, and between the nodes E and Y. The route <X, D, E, Y> will be referred to as a “stabilized route”.

However, in an environment where nodes that belong to a wireless network are fixedly installed and nodes are not frequently added or deleted, the route determining method that relies on the loop sensing process does not need to be often used after the nodes perform route learning and a route is stabilized. Accordingly, after a route is stabilized, i.e., after a stabilized route is formed, each node on the stabilized route changes the value of the loop sensing flag assigned to a link extending from the node from “1” to “0” such that the loop sensing process will no longer be performed. That is, the loop sensing flag L=0 is assigned to the links between the nodes X and D, between the nodes D and E, and between the nodes E and Y.

<Frame Format>

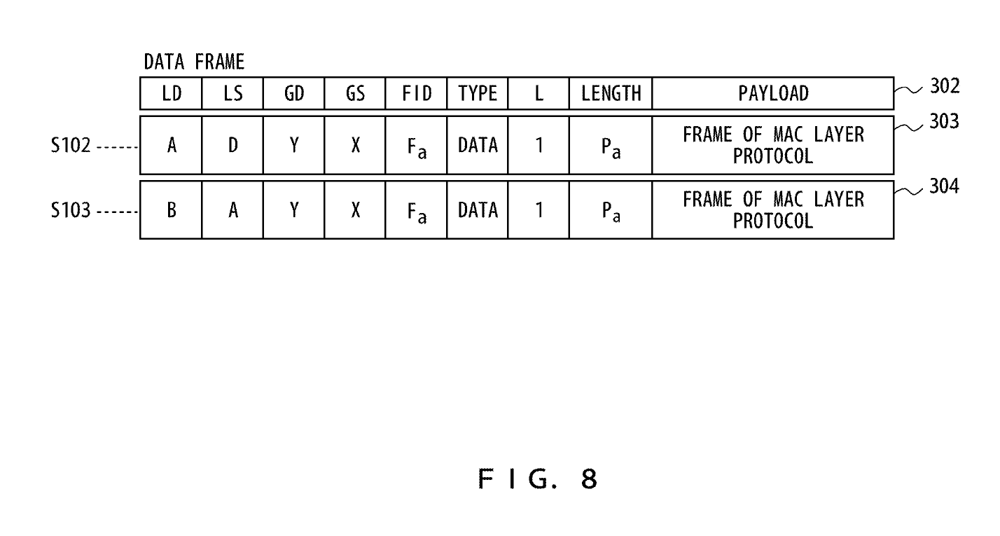

FIG. 8 illustrates an exemplary format of a frame used in the embodiment. The frame format described in the following is simply an example, and hence the frame may include fields that may be variously ordered, or may include a field that is not illustrated.

A data frame 302 in this example includes a payload and a header having the fields LD, LS, GD, GS, FID, type, L, and length. L indicates a loop sensing flag field.

The LD field, the LS field, the GD field, and the GS field of the data frame 302 respectively indicate the node IDs of node apparatuses that are an LD, an LS, a GD, and a GS of the data frame 302. The FID field of the data frame 302 indicates an FID generated and assigned to the data frame 302 by the node apparatus that is the GS of the data frame 302.

The type field of the data frame 302 indicates a predetermined constant indicating the type “data frame”. The length field of the data frame 302 indicates the length of the payload. The payload of the data frame 302 is a PDU of a protocol at a layer that is higher than the layer of the protocol that defines the data frame 302.

Assume, as an example, that a MAC sublayer is further virtually divided into two sublayers. A frame of a first embodiment may be defined by a lower of the two virtual sublayers, that is, the payload may include a PDU of another protocol (e.g., Ethernet) defined by the MAC sublayer. In other words, the frame in accordance with the first embodiment may be a frame that encapsulates an Ethernet frame defined by the second layer. In this case, the upper-layer manager 111 is a processing unit that processes an Ethernet frame and thus may be achieved using a publicly known MAC chip.

The loop sensing flag is introduced to improve the throughput of data transfer and the resources of a memory and a CPU by skipping the processes for loop sensing when a data frame is transferred through a stabilized route.

The loop sensing flag is, in particular, a value of “0” or “1”. As long as the loop sensing flag can provide information to determine whether a data frame is to be transferred through a stabilized route, the loop sensing flag may be, of course, a value that is not “0” or “1”. The value of the loop sensing flag is also called a “route stability indicator”. A process that relies on the value of a loop sensing flag (route stability indicator) is determined and performed by the link manager 108 and the data frame manager 110 of the node apparatus 100, and these units are also called route stability indicator manager.

The receiver 101, the frame divergence manager 106, the link manager 108, and the hello frame generator 112 are included in route information obtainer that obtains information related to a route through transmission and reception of a hello frame.

The default value of a loop sensing flag is “1”. That is, anode apparatus in an initial state performs a process for loop sensing.

However, as illustrated in FIG. 7, once a stabilized route is formed, “0” is set for the loop sensing flags for the links that constitute the stabilized route.

A behavior of a node changes as follows in accordance with which of 0 or 1 the “loop sensing flag” is.

Receiving a data frame with 1 stored in the field “loop sensing flag”, each node apparatus performs operations that are similar to operations in a comparative example described hereinafter.

To transmit (transfer) a data frame with 1 stored in the field “loop sensing flag”, each node apparatus performs operations that are similar to operations in the comparative example described hereinafter.

When receiving a data frame with 0 stored in the field “loop sensing flag”, each node apparatus does not perform a check operation for loop sensing.

In the transmitting (transferring) of a data frame with 0 stored in the field “loop sensing flag”, each node apparatus does not perform a registration operation for the FID management table.

That is, when the loop sensing flag is “1”, the transmitting process and the receiving process are identical with processes in the comparative example; when the loop sensing flag is “0”, the receiving process does not include making a judgment on whether a loop has been sensed, and the transmitting process does not include performing a registration operation for the FID management table.

Each node apparatus changes the value of a loop sensing flag in the following situations.

The value of a loop sensing flag is changed from “0” to “1” in the following situations.

(A1) Transmission to a route that has not been used during some period of time
(A2) First transmission after a route change
(A3) Transmission to a route whose hop count has changed
(A4) Transmission to a route whose evaluation value (score) has changed
(A5) Transmission to a route that was looped last time

In (A1), referencing the FID management table 105 allows a determination to be made as to whether a route was used during some period of time just prior.

The change in hop count of (A3) and the evaluation value of a route of (A4) may be obtained from, for example, information included in a hello header of a hello frame temporarily stored in the adjacent-node management table 103.

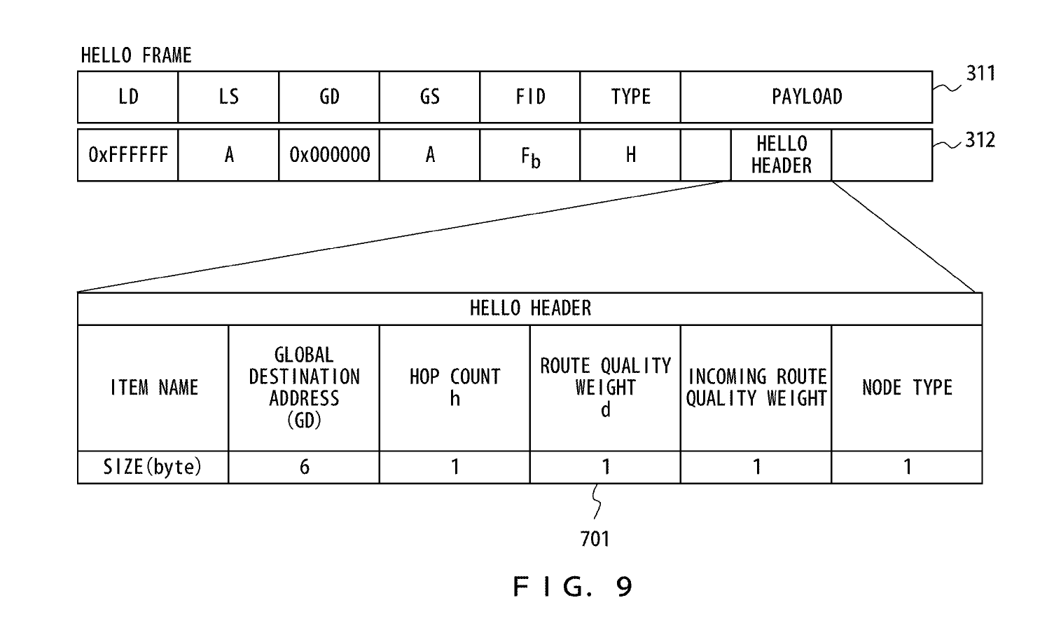

FIG. 9 illustrates an exemplary format of a hello frame.

A hello header 701 includes a GD, a hop count h, a route quality weight d, an incoming route quality weight, and a node type, as will be described hereinafter. The route quality weight d may be used as the evaluation value of a route of (A4). As will be described hereinafter, the change in hop count of (A3) and the evaluation value of a route of (A4) may be obtained from information included in a hello frame.

In regard to the “route that was looped last time” of (A5), when a loop route such as <A, B, C, A> is formed as a result of the previous transmitting of a data frame from the node A to the node B in, for example, FIG. 6 and a data frame is again transmitted from the node A to the node B, a value of “0” of a loop sensing flag is changed to “1”.

The value of a loop sensing flag is changed from “1” to “0” in the following situations.

(B1) Transmission through a link within a stabilized route

### (B2) Transmission to a GD

In (B1), the value of a loop sensing flag may be changed from “1” to “0” when, for example, a data frame is transmitted from a node apparatus that has a link extended therefrom and the order of a weight assigned to the link remains the same since the last time, as will be described in detail hereinafter.

In (B2), the value of a loop sensing flag is changed from “1” to “0” when a GD is selected as an LD.

Data frames 303 and 304 are respectively the data frames in steps S102 and S103.

The data frame 303 is a data frame transmitted to the node apparatus A by the node apparatus D in step S102 in FIG. 5.

The LD field of the data frame 303 indicates the node ID of the node apparatus A (i.e., A), which is a node apparatus selected as an LD in the transmission in step S102.

The LS field indicates the node ID of the node apparatus D (i.e., D), which is an LS in the transmission in step S102.

The GD field indicates the node ID of the node apparatus Y (i.e., Y), designated by the node apparatus X, a GS, in the transmission in step S101.

The GS field indicates the node ID of the GS node apparatus X (i.e., X).

The FID field indicates an FID (hereinafter referred to as “F_{X}”) generated by the GS node apparatus.

The type field indicates a predetermined constant denoting the type “data frame”. For example, the type may be expressed by two bits and may be (00)₂.

The loop sensing flag field (L) stores the value of the loop sensing flag.

The length field indicates the length Pₐ of the payload of the data frame 302. The length may be expressed, for example, in units of bytes or may be expressed in a different manner.

The data frame 303 includes a frame of a MAC layer protocol (e.g., Ethernet frame) as a payload.

The data frame 304 is a data frame transmitted to the node apparatus B by the node apparatus A in step S103 in FIG. 5.

The LD field indicates the node ID of the node apparatus B (i.e., B) selected as an LD in the transmission in step S103. That is, for transferring, the node apparatus A rewrites the LD field.

The LS field indicates the node ID of the node apparatus A (i.e., A), an LS in the transmission in step S103. That is, for transferring, the node apparatus A rewrites the LS field and sets the own node ID.

The fields GD, GS, FID, type, and length and the content of the payload are the same as those of the data frame 303 received by the node apparatus A.

As illustrated in FIG. 9, a hello frame 311 includes a header that includes the fields LD, LS, GD, GS, FID, type, and payload. A specific example of the hello frame 311 is a hello frame 312. As described above, a hello frame is a type of control frame to communicate control information and is used by the node apparatus 100 to report the presence thereof to another node apparatus. Upon receipt of a hello frame, a node apparatus stores, in the adjacent-node management table 103 thereof, information related to the presence of a node apparatus that is the source of the hello frame, updates the adjacent-node management table 103, and updates the weighting table 104.

The LD field of the hello frame 311 indicates a unique value denoting broadcast to all of the node apparatuses adjacent to the node apparatus that transmits the hello frame 311. The “broadcast” in this example means broadcast to all adjacent node apparatuses. For the purpose of description, this example is based on the assumption that a node ID is expressed by three bytes and “0x” indicates hexadecimal. 0x000000 and 0xFFFFFF are reserved and are not used as ordinary node IDs. As with the hello frame 312, the LD fields of all of the hello frames in this example each indicate 0xFFFFFF as a unique value denoting broadcast to all of the node apparatuses adjacent to the node apparatus that transmits the hello frame.

The LS field of the hello frame 311 indicates the node ID of the node apparatus that transmits the hello frame 311. Thus, the LS field of the hello frame 312 transmitted by the node apparatus A indicates A, the node ID of the node apparatus A.

The type field of the hello frame 311 indicates a predetermined constant denoting the type “hello frame”. In particular, the type “hello frame” is indicated by a predetermined constant of H, as illustrated in the hello frame 312, and, for example, H=(10)₂ may be satisfied.

The payload includes a hello header.

The hello header includes GD, hop count h, route quality weight d, incoming route quality weight, and node type.

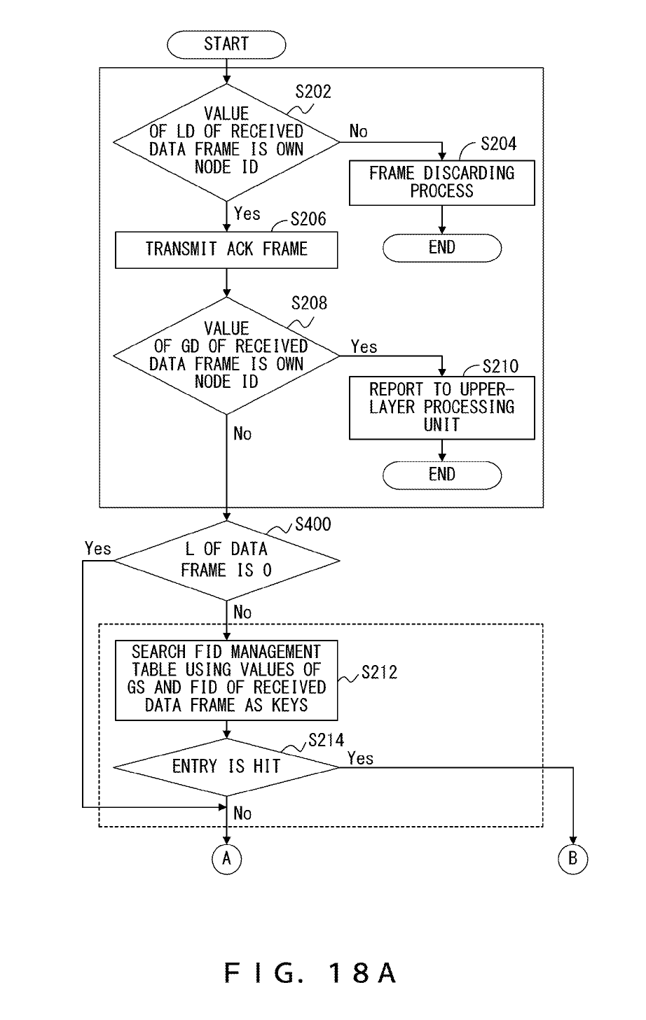

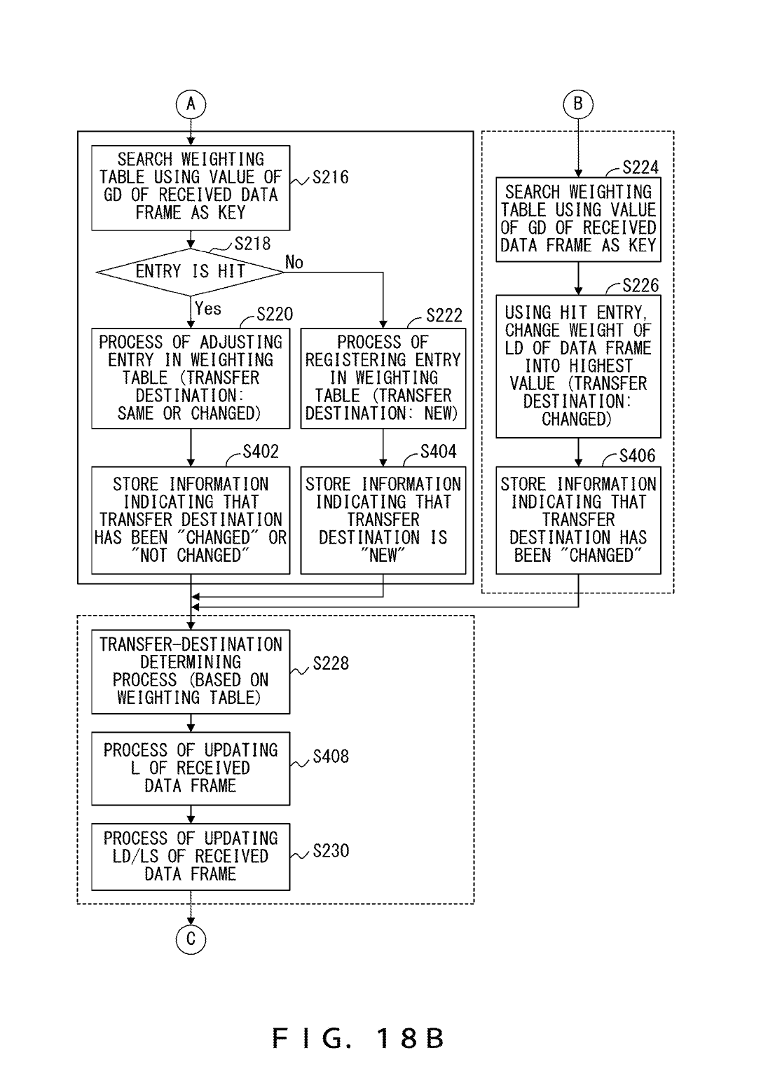

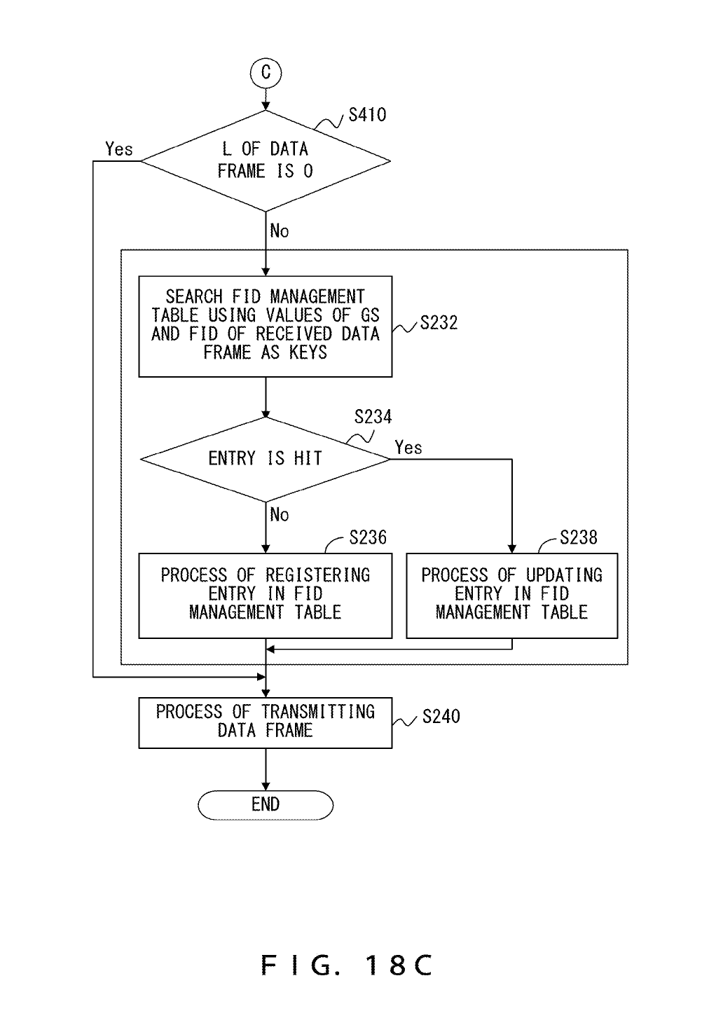

The GD is, for example, information on a global destination address (GD) corresponding to a weighting table held by a node apparatus that is the initial source (GS) of a hello frame that includes a hello header in FIG. 18.

The hop count h is, for example, information on the number of hops on a route from the source of the hello frame to a node apparatus that is set as the GD.

The route quality weight d is a value determined from delay on a route to the GD. The route quality weight d may be used as an evaluation value of the route of (A4).

The incoming route quality weight is a value determined according to the quality of a communication from a communications-partner node apparatus (in this example, the node apparatus that has transmitted the hello frame) to the node apparatus.

The node type defines a type such as gateway, relay, or terminal.

Thus, a change in the hop count of (A3) and the evaluation value of a route of (A4) may be obtained from information included in, for example, the hello header of a hello frame.

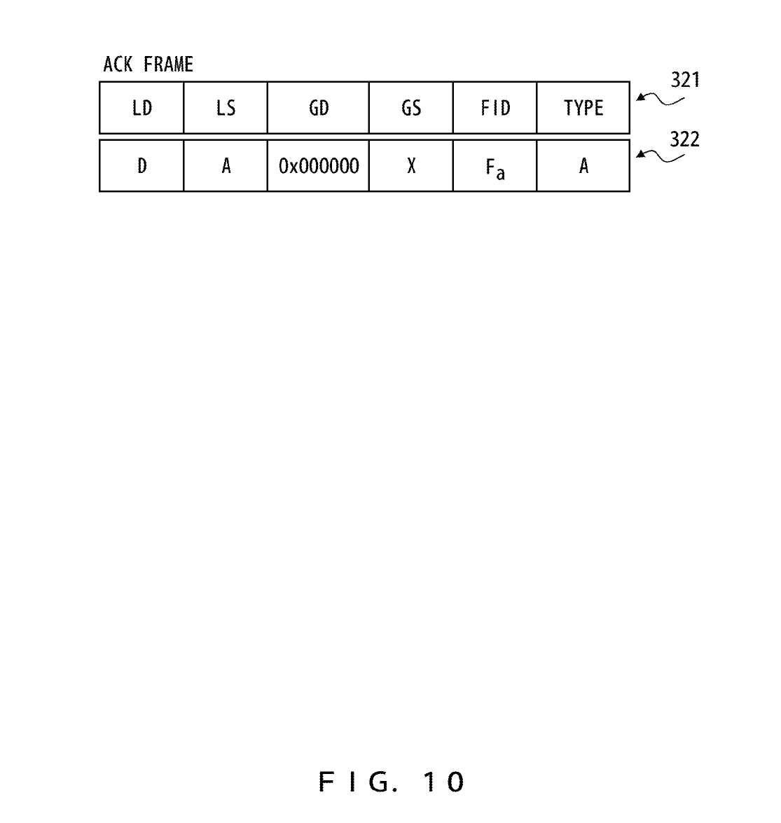

As with an ACK frame 321 of FIG. 10, the ACK frame in this example has a header that includes the fields LD, LS, GD, GS, FID, and type. A specific example of the ACK frame 321 is an ACK frame 322. The ACK frame 322 is an ACK frame the node apparatus A responsively sends to the node apparatus D when the node apparatus D transmits the data frame 303 to the node apparatus A in step S102 in FIG. 5.

The LD field of the ACK frame 321 indicates the node ID of an adjacent node apparatus that has transmitted a data frame that has caused the transmission of the ACK frame 321. Hence, for example, the LD field of the ACK frame 322 indicates D, the node ID of the node apparatus D, which is adjacent to the node apparatus A and has transmitted the data frame 303 that has caused the node apparatus A to transmit the ACK frame 322.

The LS field of the ACK frame 321 indicates the node ID of the node apparatus that transmits the ACK frame 321. Thus, the LS field of the ACK frame 322 transmitted by the node apparatus A indicates A, the node ID of the node apparatus A.

As with hello frames, ACK frames are not transferred, and hence all of the ACK frames in this example include the GD field indicating 0x000000, a unique value denoting null.

The GS field and the FID field of the ACK frame 321 have copied thereto the values of the GS field and the FID field of the data frame that has caused the transmission of the ACK frame 321. As described above, the combination of the values of a GS field and an FID field uniquely identifies a data frame within the network. Hence, the node apparatus that transmits the ACK frame 321 copies values from a received data frame so that the node apparatus that receives the ACK frame 321 can identify which data frame the ACK frame 321 is directed to.

Thus, for example, as with the data frame 303, the ACK frame 322 transmitted upon receipt of the data frame 303 includes the values of the GS field and the FID field, which are respectively X and F.

The type field of the ACK frame 321 indicates a predetermined constant denoting the type “ACK frame”. In particular, as exemplified by the ACK frame 322, the type “ACK frame” is indicated by A, a predetermined constant, and A may satisfy, for example, A(11)₂.

<Table Format>

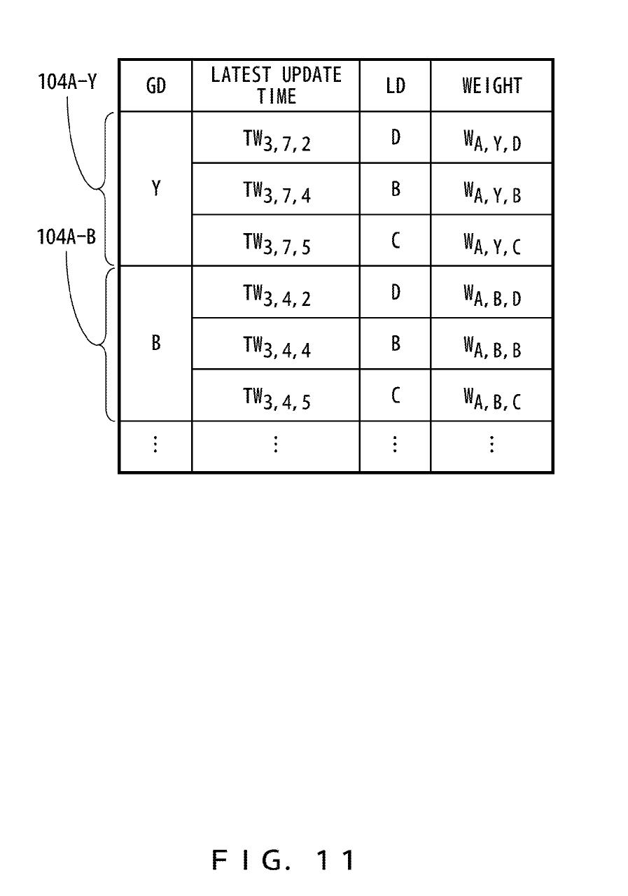

FIG. 11 illustrates an example of the weighting table in FIG. 2. FIG. 11 depicts as a specific example a weighting table 104A-i (1≦i≦M) of the node apparatus A in FIG. 2. As described above, “weighting table 104” is a generic name for a plurality of weighting tables each managed for a GD. The weighting tables 104A-i (1≦i≦M) each record a corresponding GD.

The weighting tables 104-i each include one or more entries, and each entry includes a latest update time field, an LD field, and a weight field. The latest update time field has stored therein a time when the entry was updated most recently to learn a weight, the LD field has stored therein the node ID of an adjacent node apparatus, and the weight field has stored therein a weight value associated with the adjacent node apparatus.

In the network 10 in FIG. 1, the node apparatuses D, B, and C are adjacent to the node apparatus A. Thus, a weighting table 104A-Y includes three entries, each of which corresponds to one of the three adjacent nodes D, B, and C. The contents of the entries of the weighting table are as follows.

The latest update time field has stored therein a latest update time TW_{A,Y,D} of the entry.

The LD field has the node ID of an adjacent node apparatus stored therein. When, for example, the node D is an LD, “D” is stored in the LD field.

The weight field has stored therein a weight associated with an adjacent node apparatus. For the transmission of, for example, a data frame whose GD is the node Y, the weight associated with the node apparatus D is W_{A,Y,D}.

The descriptions above are also applicable to the contents of the entries of the weighting table 104A-B, which has stored therein weights each associated with an LD for the transmission of a data frame whose GD is the node B.

In the weighting table 104, as long as the GD is the same, even when data frames each having a different combination of FID and GS are transmitted, the weight of a transmission-destination LD is updated for each transmission. In, for example, transmitting a certain data frame, even when the weight of a specific LD becomes large (priority is lowered) due to a link fault, as long as the transmission of another data frame (having the same GD and the same LD) succeeds soon owing to the resolution of the link fault, the weight of the LD becomes small (priority is enhanced). Conversely, when the transmissions of a plurality of different data frames (having the same GD and the same LD) consecutively fail due to a link fault, only the weight of the corresponding LD may become the highest value even when an attempt is made only once to transmit a data frame with a combination of the same FID and the same GS.

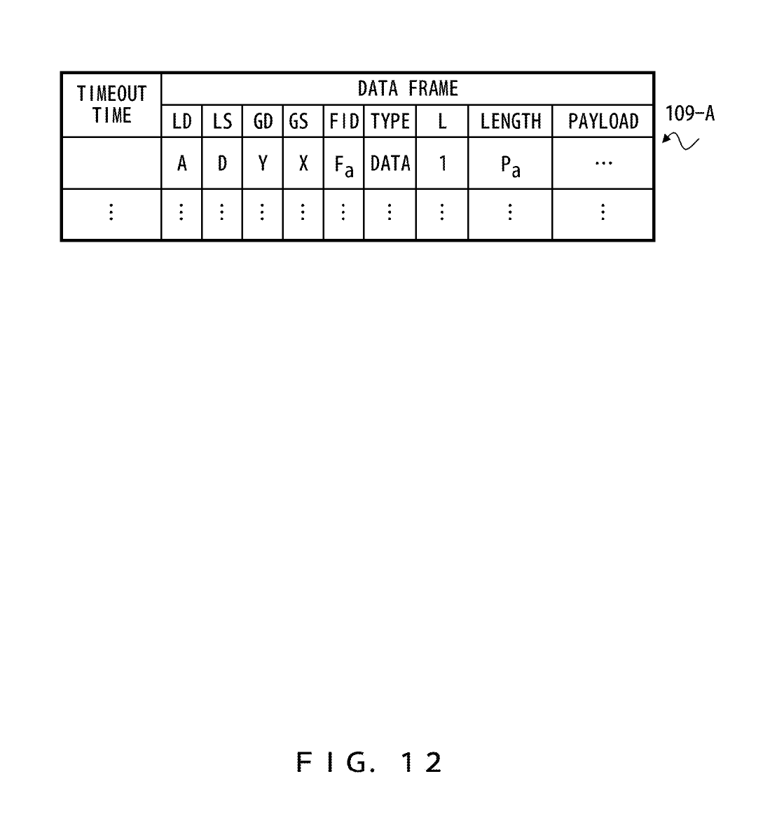

FIG. 12 exemplifies a certain entry within a buffer 109-A of the node apparatus A.

The buffer 109 includes a plurality of entries each corresponding to an individual data frame received by the receiver 101. Each entry includes a timeout time and a received data frame.

In particular, when the node apparatus A receives the data frame 303 from the node apparatus D in step S102 in FIG. 5, an entry that includes a timeout time TI_{3,j} and the data frame 303 is created in the buffer 109-A. The timeout time TI_{3,j} in FIG. 12 indicates how long the node apparatus A will wait for an ACK frame for the data frame 304 to be received after the data frame 304 is transmitted. That is, a timeout occurs when the node apparatus A cannot receive an ACK frame for the data frame 304 from the node apparatus B before the timeout time TI_{3,j}, thereby causing the node apparatus A to determine that the transmission of the data frame 304 to the node apparatus B has failed.

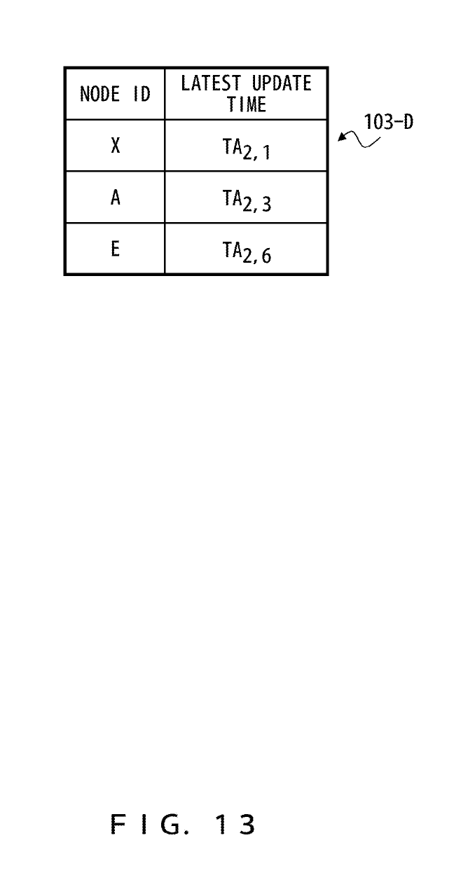

FIG. 13 illustrates an example of the adjacent-node management table 103 illustrated in FIG. 2. The adjacent-node management table 103 includes a node ID field and a latest update time field.

In, for example, the network 10 in FIG. 1, the node apparatuses X, A, and E are adjacent to the node apparatus D. Thus, an adjacent-node management table 103-D of the node apparatus D includes three entries each corresponding to one of the three adjacent node apparatuses X, A, and E. For each entry corresponding to an adjacent node apparatus Nᵢ (i=X, A, E), the node ID field has stored therein the node ID of an adjacent node apparatus, and the latest update time field has stored therein a time when the entry was updated most recently.

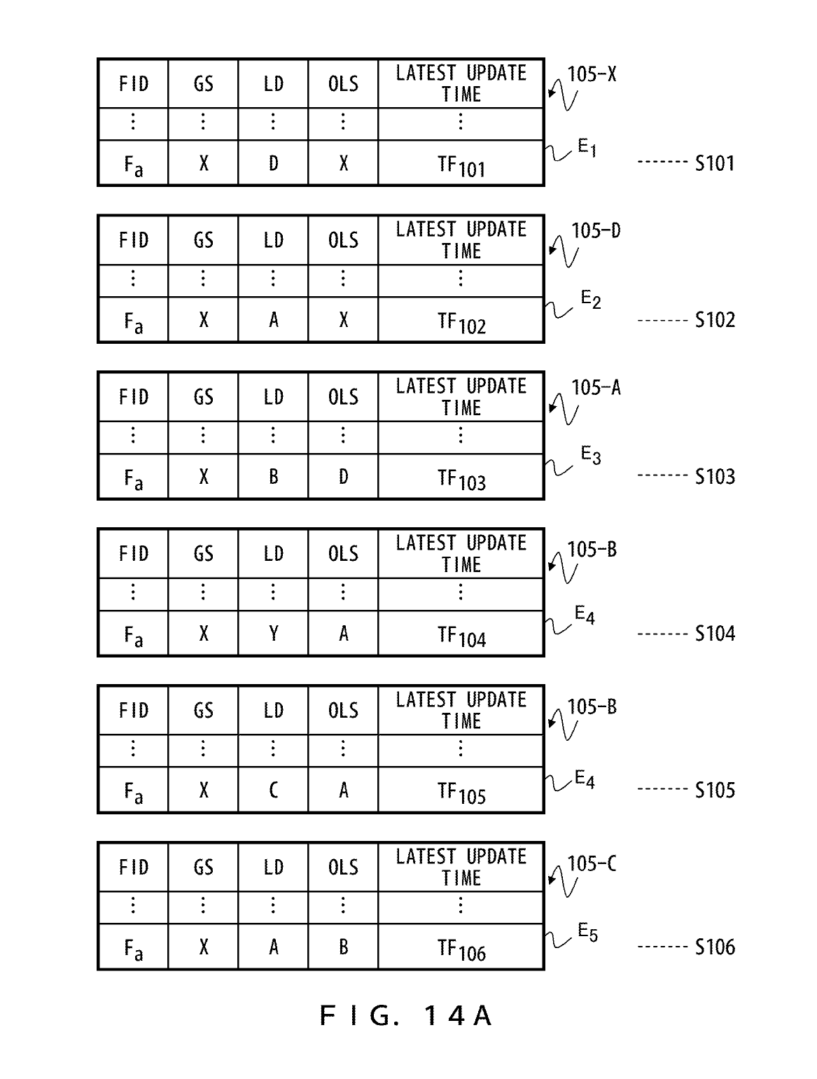

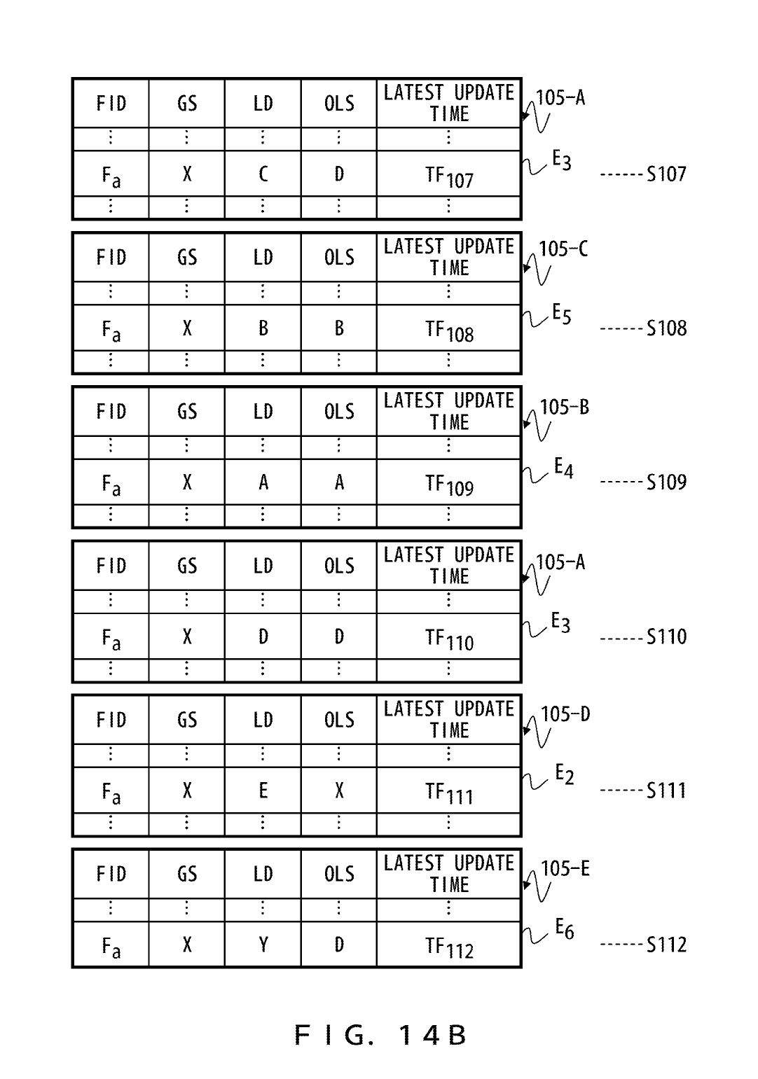

FIGS. 14A and 14B illustrate examples of the FID management table 105. As illustrated in FIGS. 14A and 14B, the FID management table 105 includes the fields FID, GS, LD, OLS, and the latest update time.

The FID field and the GS field of the FID management table 105 are fields to uniquely identify a data frame and respectively have stored therein the values from the FID field and the GS field of a received data frame.

The LD field of the FID management table 105 has stored therein the node ID of an adjacent node apparatus selected as an LD most recently in order to transmit a data frame identified by the values of the FID field and the GS field.

The OLS field of the FID management table 105 has stored therein the node ID of an adjacent node apparatus indicated by the LS field of a data frame identified by the values of the FID field and the GS field when this data frame was initially received. The OLS field is also used to exclude an OLS from LD candidates in the selecting of an LD to transfer a data frame and is also used to determine an LD for a backtrack operation.

The latest update time field of the FID management table 105 has stored therein a time when the entry was updated most recently.

The FID management table 105 in FIG. 14 is achieved by the DRAM 204 or the flash memory 205 in FIG. 3. The FID management table 105 is an example of storage that stores the following pieces of information (a1)-(a3) in association with each other.

(a1) Frame identification information to identify a frame
(a2) Transmission-destination-node identification information to identify a node apparatus that is a transmission destination of a frame from among a plurality of adjacent node apparatuses
(a3) Origin-node identification information to identify a node apparatus that is the first to have transmitted a transmission-object frame

An example of the frame of (a1) is a data frame. An example of frame identification information is the combination of the values of the GS field and the FID field.

A specific example of the node identification information of (a2) may be the node ID of an adjacent node apparatus stored in the LD field of the FID management table 105.

A specific example of the origin-node identification information of (a3) is a node ID stored in the OLS field of the FID management table 105.

When the node apparatus 100 relays a data frame, the value of the LS field of the data frame that is indicated when the node apparatus 100 receives the data frame for the first time is stored in the OLS field of the FID management table 105. That is, the node ID of anode apparatus that is the first to have transmitted the frame is stored in the OLS field.

When the node apparatus 100 itself is a GS, the own node ID is stored in the OLS field of the FID management table 105. That is, when the node apparatus 100 itself generates a transmission-object frame, the OLS field has stored therein the own node ID, i.e., identification information of the node apparatus 100 itself. In other words, the node ID stored in the OLS field is the node ID of a node apparatus that the node apparatus 100 recognizes as the origin of the transmission-object frame within a range of a hop count of 1 or less centered at the node apparatus 100 itself.

The weighting table 104 in FIG. 2 is achieved by the DRAM 204 or the flash memory 205 in FIG. 3. The weighting table 104 is an example of storage that stores, in association with a GD (ultimate destination of a data frame), transmission possibility information that indicates a possibility of transmission to each of a plurality of adjacent node apparatuses.

In the comparative example above, the transmission possibility information is indicated, in particular, by one or more entries each of which includes a set of the node ID of an LD field and a weight value. Transmission possibility is expressed as, for example, “not transmittable with a weight value of 1, and transmittable with a weight value that is less than 1”.

The data frame manager 110 in FIG. 2 is achieved by, for example, the MPU 201 and the DRAM 204 in FIG. 3 and is an example of updater that updates transmission possibility information. When frame identification information to identify a received frame received by receiver such as the receiver 101 is stored as the frame identification information of (a1) in storage such as the FID management table 105, the data frame manager 110, which serves as the updater, updates transmission possibility information.

The transmission possibility information updated in this case is transmission possibility information stored in storage such as the weighting table 104 in association with a received-frame destination, which is an ultimate destination (i.e., GD) indicated by the received frame. The transmission possibility information is updated in a manner such that “not transmittable” is indicated by the possibility of transmission to a first adjacent node apparatus identified by the transmission-destination-adjacent-node identification information of (a2) stored in storage such as the FID management table 105 in association with received-frame identification information. For example, the data frame manager 110 serves as the updater and performs an operation of “setting a weight of 1 in an entry of the weighting table 104 that has, in the LD field, a value that is the same as the value in the LD field of the FID management table 105”.

The data frame manager 110 and the transmitter 102 together function as transmitter that selects, from a plurality of adjacent node apparatuses, a second node apparatus to which data is transmittable and transmits a received frame to the second node apparatus. The data frame manager 110 serves as a portion of the transmitter and selects a second node apparatus according to transmission possibility information stored in storage such as the weighting table 104 in association with a received-frame destination. Assume that storage such as the FID management table 105 records a third node apparatus as the origin-node identification information of (a3) associated with the received-frame identification information.

When transmitted-frame identification information is stored as the frame identification information of (a1) in storage such as the FID management table 105, the data frame manager 110, which serves as the transmitter, determines that data is not transmittable to the third adjacent node apparatus regardless of transmission possibility information. That is, the data frame manager 110 determines that “regardless of a weight value, data is not transmittable to an adjacent node apparatus that is an OLS”, and excludes the adjacent node apparatus that is an OLS from LD candidates. Then, the data frame manager 110 serves as transmitter and selects the second adjacent node apparatus, i.e., a node apparatus to which data is transmittable, unlike the case of the third adjacent node apparatus.

The data frame manager 110 and the transmitter 102 also function as backtracker together. Serving as backtracker, the data frame manager 110 and the transmitter 102 transmit a received frame to the third node apparatus when transmission possibility information in storage such as the weighting table 104 does not indicate a node apparatus to which data is transmittable from among a plurality of adjacent node apparatuses, and received-frame identification information is stored as the frame identification information of (a1) in storage such as the FID management table 105.

The fact that “data is not transmittable to any of the plurality of adjacent node apparatuses” means that “there is only an adjacent node apparatus for which ‘not transmittable’ is indicated by transmission possibility information, e.g., an adjacent node apparatus with a weight of 1, or there is only a third adjacent node apparatus for which ‘not transmittable’ is indicated regardless of transmission possibility information, as described above”.

FIGS. 14A and 14B illustrate, as specific examples, the FID management table 105 of each node apparatus in steps S101-S112 in FIG. 5. The times at which steps S101-S112 are performed will respectively be indicated as TF₁₀₁-TF₁₁₂.

In the transmitting of a data frame to the node apparatus D in step S101, the node apparatus X creates a new entry E₁ in an FID management table 105-X.

The node apparatus X registers the values of the FID and the GS of the transmitted data frame in the FID field and the GS field of the entry E₁.

As described above, the values of the GS and the FID of the data frame are not rewritten even when the data frame is transferred within the network 1. Hence, the values of the FID and the GS of the data frame transmitted in steps S101-S112 within the network 1 in FIG. 5 are respectively Fₐ and X, as in the case of the data frames 303 and 304 in FIG. 8. Thus, in step S101, the node apparatus X registers values of Fₐ and X in the FID field and the GS field of the entry E₁, respectively. Similarly, in the following steps, steps S102-S112, other node apparatuses each register values of Fₐ and X in the FID field and the GS field of an entry of the FID management table 105. Accordingly, descriptions of an FID field and a GS field will be omitted in the following.

In step S101, the node apparatus X registers D, i.e., the node ID of the node apparatus D selected as an LD, in the LD field of the entry E₁. In regard to a specific data frame uniquely identified by a set of the values of the GS and the FID, an OLS is an adjacent node apparatus identified by a node ID designated by the LS of the specific data frame when the specific data frame was initially received.

However, defining an OLS like this will lead to an undefined OLS for a data frame from the perspective of the node apparatus X when, for example, the node apparatus X itself is a GS and transmits the data frame. Accordingly, the definition of OLS will be expanded in the following. In particular, a definition is given such that “when a node apparatus Nᵢ itself is a GS and transmits a data frame, an OLS for the data frame from the perspective of the node apparatus Nᵢ itself is the node apparatus Nᵢ itself”. In other words, an OLS is a node apparatus recognized as the origin of a data frame from the perspective of a node apparatus Nᵢ within the range of a network that the node apparatus Nᵢ directly recognizes. The “range of a network that the node apparatus Nᵢ directly recognizes” is the range of a hop count of 1 or less from the perspective of the node apparatus N₁, and, in particular, only the node apparatus Nᵢ itself and a node apparatus adjacent to the node apparatus Nᵢ are within the range.

In view of the expanded definition of OLS above, the value that the node apparatus X registers in the OLS field of the entry E₁ in step S101 is the node ID of the node apparatus X itself (i.e., X). When the node apparatus X receives a data frame that has X as the value of the GS and Fₐ as the value of the FID, the node apparatus X may recognize that “the node apparatus X has received a data frame that is transmitted by the node apparatus X itself in the past” according to the entry E₁ created as described above.

In step S101, the node apparatus X registers a current time TF₁₀₁ in the latest update time field of the entry E. Similarly, in the following steps, steps S102-S112, other node apparatuses each register times TF₁₀₂-TF₁₁₂, i.e., times at which steps S102-S112 are respectively performed, in the latest update time fields of entries of the FID management table 105. Accordingly, descriptions of the latest update time field will be omitted in the following.

Upon receipt of a data frame from the node apparatus X in step S101, the node apparatus D creates a new entry E₂ in an FID management table 105-D in the transmitting of the data frame to the node apparatus A in step S102. Then, the node apparatus D registers X and A in the OLS field and the LD field of the entry E₂, respectively.

Upon receipt of the data frame from the node apparatus D in step S102, the node apparatus A creates a new entry E₃ in an FID management table 105-A in the transmitting of the data frame to the node apparatus B in step S103. Then, the node apparatus A registers D and B in the OLS field and the LD field of the entry E₃, respectively.

Upon receipt of the data frame from the node apparatus A in step S103, the node apparatus B creates a new entry E₄ in an FID management table 105-B in the transmitting of the data frame to the node apparatus Y in step S104. Then, the node apparatus B registers A and Y in the OLS field and the LD field of the entry E₄, respectively.

However, the transmission in step S104 fails due to a fault in a link between the node apparatuses B and Y. That is, a timeout occurs since the node apparatus B cannot receive an ACK frame from the node apparatus Y. Consequently, as in the case of step S105, the node apparatus B selects the adjacent node apparatus C as a next LD and transmits the data frame to the node apparatus C.

The data frames transmitted in steps S104 and S105 have Fₐ as the value of the FID and X as the value of the GS and thus are identical with each other. Accordingly, in step S105, the node apparatus B does not create a new entry but updates the existing entry E₄. In particular, in step S105, the node apparatus B overwrites the value of the LD field of the entry E₄ so as to register value C. No matter how many times the node apparatus B transmits the same data frame that has X as the value of the GS and Fₐ as the value of the FID, the fact remains that “the node apparatus B received the data frame initially from the node apparatus A”. Hence, A remains as the value of the OLS field of the entry E₄ without being rewritten.

Upon receipt of the data frame from the node apparatus B in step S105, the node apparatus C creates a new entry E₅ in an FID management table 105-C in the transmitting of the data frame to the node apparatus A in step S106. Then, the node apparatus C registers B and A in the OLS field and the LD field of the entry E₅, respectively.

Upon receipt of the data frame from the node apparatus C in step S106, the node apparatus A finds the entry E₃ by searching the FID management table 105-A using the values of the GS and the FID of the received data frame as keys. Finding the entry E₃, the node apparatus A may recognize that “the node apparatus A has received in step S106 a data frame that is the same as the data frame that the node apparatus A itself transmitted in step S103”.

Accordingly, in the transmitting of the data frame to the node apparatus C in the following step, step S107, the node apparatus A does not create a new entry in the FID management table 105-A but updates the existing entry E₃. In particular, in step S107, the node apparatus A overwrites the value of the LD field of the entry E₃ so as to register value C. D remains as the value of the OLS field of the entry E₃ without being rewritten.

Upon receipt of the data frame from the node apparatus A in step S107, the node apparatus C finds the entry E₅ by searching the FID management table 105-C using the values of the GS and the FID of the received data frame as keys. Finding the entry E₅, the node apparatus C may recognize that “the node apparatus C has received in step S107 a data frame that is the same as the data frame that the node apparatus C itself transmitted in step S106”.

Accordingly, in the transmitting of the data frame to the node apparatus B in the following step, step S108, the node apparatus C does not create a new entry in the FID management table 105-C but updates the existing entry E₅. In particular, in step S108, the node apparatus N₅ overwrites the value of the LD field of the entry E₅ so as to register value B. B remains as the value of the OLS field of the entry E₅ without being rewritten.

Upon receipt of the data frame from the node apparatus C in step S108, the node apparatus B finds the entry E₄ by searching the FID management table 105-B using the values of the GS and the FID of the received data frame as keys. Finding the entry E₄, the node apparatus B may recognize that “the node apparatus B has received in step S108 a data frame that is the same as the data frame that the node apparatus B itself transmitted in step S105”.

Accordingly, in the transmitting of the data frame to the node apparatus A in the following step, step S109, the node apparatus B does not create a new entry in the FID management table 105-B but updates the existing entry E₄. In particular, in step S109, the node apparatus B overwrites the value of the LD field of the entry E₄ so as to register value A. A remains as the value of the OLS field of the entry E₄ without being rewritten.

Upon receipt of the data frame from the node apparatus Bin step S109, the node apparatus A finds the entry E₃ by searching the FID management table 105-A using the values of the GS and the FID of the received data frame as keys. Finding the entry E₃, the node apparatus A may recognize that “the node apparatus A has received in step S109 a data frame that is the same as the data frame that the node apparatus A itself transmitted in step S103”.

Accordingly, in the transmitting of the data frame to the node apparatus D in the following step, step S110, the node apparatus A does not create a new entry in the FID management table 105-A but updates the existing entry E₃. In particular, in step S110, the node apparatus A overwrites the value of the LD field of the entry E₃ so as to register value D. D remains as the value of the OLS field of the entry E₃ without being rewritten.

Upon receipt of the data frame from the node apparatus A in step S110, the node apparatus D finds the entry E₂ by searching the FID management table 105-D using the values of the GS and the FID of the received data frame as keys. Finding the entry E₂, the node apparatus N₂ may recognize that “the node apparatus D has received in step S110 a data frame that is the same as the data frame that the node apparatus D itself transmitted in step S102”.

Accordingly, in the transmitting of the data frame to the node apparatus E in the following step, step S111, the node apparatus D does not create a new entry in the FID management table 105-D but updates the existing entry E₂. In particular, in step S111, the node apparatus D overwrites the value of the LD field of the entry E₂ so as to register value E. X remains as the value of the OLS field of the entry E₂ without being rewritten.

Upon receipt of a data frame from the node apparatus D in step S111, the node apparatus E creates a new entry E₆ in an FID management table 105-E in the transmitting of the data frame to the node apparatus Y in step S112. Then, the node apparatus E registers D and Y in the OLS field and the LD field of the entry E₆, respectively.

<Process of Transmitting and Receiving Data Frame>

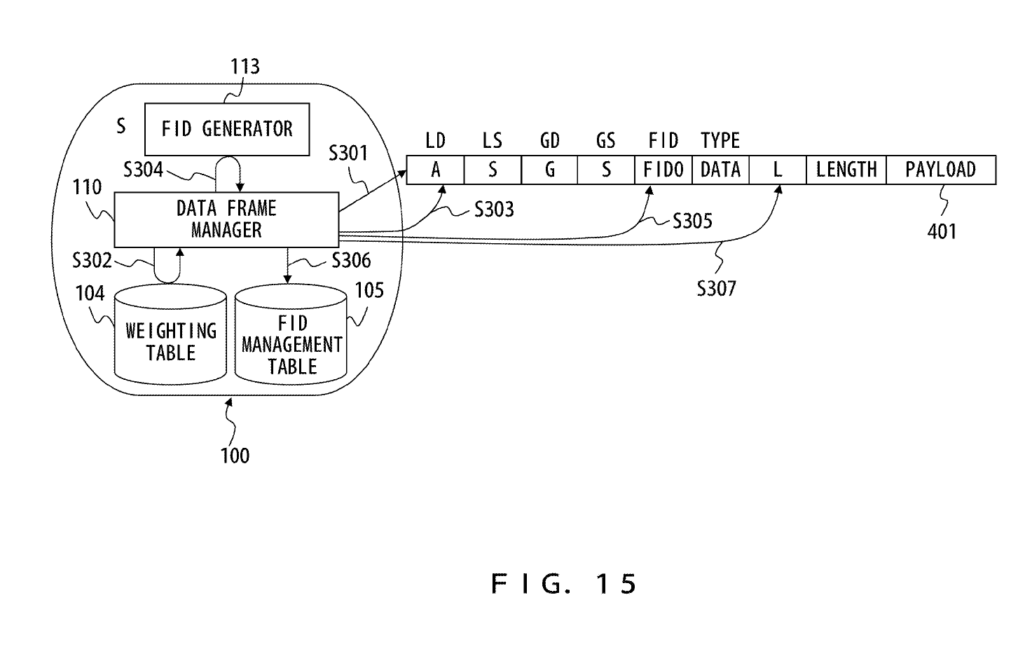

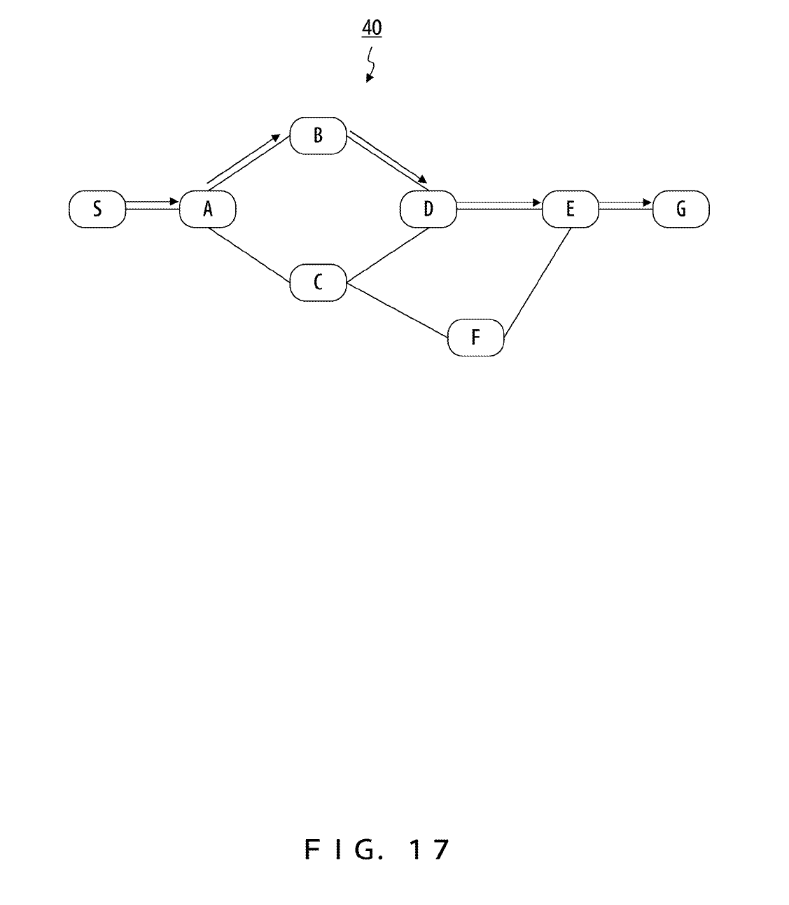

With reference to FIGS. 15-20, detailed descriptions will be given of an operation to transmit a data frame by the node apparatus 100 in the ad-hoc network 10. This example is based on an ad-hoc network 40 illustrated in FIG. 17. Assume that a data frame is transmitted from a node S to a node G for the first time.

FIG. 15 illustrates an outline of a process of transmitting a data frame at a global-source (GS) node apparatus S.

In step S301, the data frame manager 110 creates a data frame 401. In particular, DATA, length, and data are respectively set in the type field, the length field, and the payload field of the data frame. “S”, the ID of the node, is set in the GS and the LS. In FIG. 15, “S”, the ID of the node S, is set in the GS and the LS. “G”, the ID of a destination node, is set in the GD.

In the following step, step S302, to select an LD, the weighting table 104 is searched, a weighting table that indicates the node G as a GD is searched, and an adjacent node having the lowest weight value is selected as an LD. In the case of FIG. 17, only the node A is adjacent to the node S, and hence A is selected as an LD of the data frame 401.

In step S303, “A”, the ID of the node A, is set in the LD field in the data frame 401.

In step S304, FID0, the FID (Frame IDentification) of the data frame that is transmitted, is obtained from the FID generator 113.

In step S305, the FID obtained in step S304 is set in the FID field of the data frame 401.

In step S306, information on the data frame 401 is registered in the FID management table 105.

In step S307, the value of a loop sensing flag is stored in the loop sensing flag field L. In this example, default value L=1 is stored.

Finally, the node S transmits the data frame 401 generated in this way to the node A, an LD.

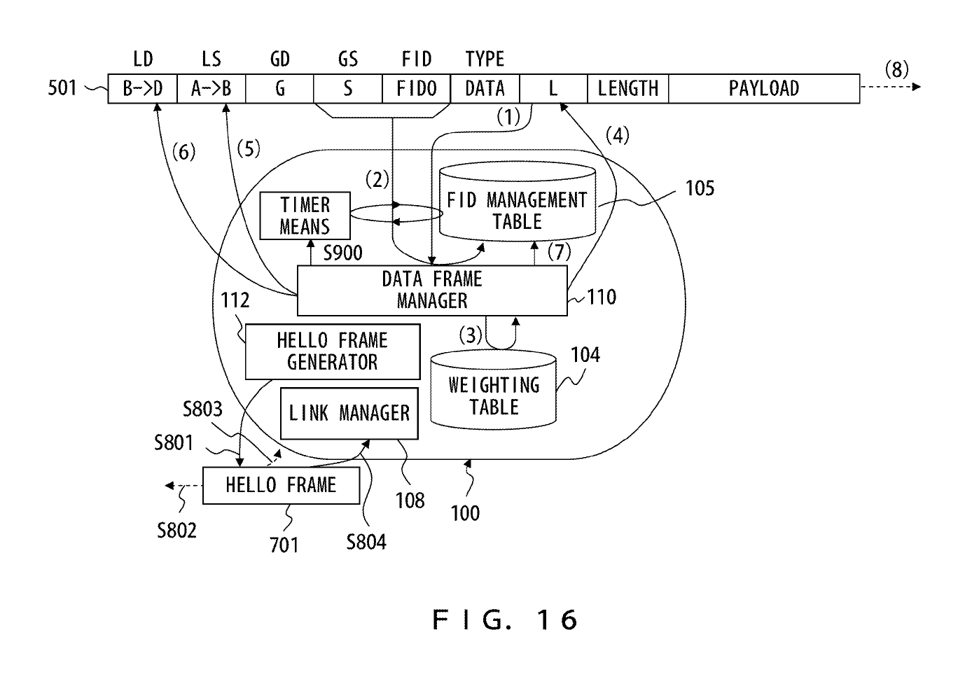

FIG. 16 schematically illustrates a process performed after the node B in the network 40 in FIG. 17 receives a data frame.

FIG. 18 illustrate a process of transferring a data frame performed by a node apparatus in accordance with the embodiment.

In the embodiment, as illustrated in FIG. 16, the node apparatus 100 transmits or receives a hello frame 701.

In particular, the hello frame generator 112 of the node apparatus 100 generates the hello frame 701 in step S801. In step S802, the hello frame 701 is transmitted from the transmitter 102.

The node apparatus 100 also receives a hello frame 701 from another node apparatus. More particularly, the receiver 101 of the node apparatus 100 receives a hello frame 701 from another node apparatus in step S803. The received hello frame 701 is sent to the link manager 108 via the frame divergence manager 106. Receiving the hello frame 701, the node apparatus 100 can obtain information related to a route to a certain node, such as a change in the pop count of the certain route and a change in the evaluation value (score) of the route.

A process performed after the data frame 501 is received starts with step S202 in FIG. 18. During the process performed after the data frame is received, as indicated by S900, the data frame manager 110 uses timer to count the time spent on performing such a process.

In step S202, a determination is made as to whether the value of the LD of the received data frame is the ID of the node itself. When the determination indicates a judgment of “No”, i.e., negative, the data frame is not to be received and is thus discarded in step S204.

When the determination in step S202 indicates a judgment of “Yes”, i.e., positive, the node B transmits an ACK frame to the transmission-source node A.

In the following step, step S208, a determination is made as to whether the value of the GD of the received data frame is the ID of the node itself. When the determination indicates a judgment of Yes, the process shifts to step S210, where this judgment is reported to the upper-layer manager 111. When the node apparatus is the GD, the upper-layer manager 111 processes a PDU of an upper layer included as a payload in the data frame.

When the determination in step S208 indicates a judgment of “No”, the process shifts to step S400.

In step S400, a determination is made as to whether “0” is set as the loop sensing flag L of the received data frame, i.e., whether a setting has been made to skip the process for loop sensing. The process of step S400, which is not performed in the comparative example, is performed by the data frame manager 110 of the node apparatus, as illustrated by (1) in FIG. 16.

When the determination in step S400 indicates a judgment of Yes, i.e., when the loop sensing flag L is “0”, and a setting has been made to skip the process for loop sensing, the process shifts to step S216.

When the determination in step S400 indicates a judgment of No, i.e., when the loop sensing flag L is “1”, and a setting has been made to perform the process for loop sensing, the process shifts to step S212.

In step S212, the FID management table 105 is searched according to the values of the GS and the FID of the received data frame.

In the following step, step S214, a determination is made as to whether the FID management table 105 includes an entry.

The processes of steps S214-S216 are indicated by (2) in FIG. 16. That is, values are read from the GS and the FID field of the data frame, and the FID management table 105 is searched using the values as keys. Then, a search result is judged.

When the determination in step S214 indicates a judgment of No, the process shifts to step S216. In step S216, the weighting table 104 is searched using the value of the GD of the received data frame as a key.

In step 218, a determination is made as to whether the value of the GD of the data frame hits an entry in the weighting table 104.

When the determination in step S218 indicates a judgment of Yes, the process shifts to step S220, where a process of adjusting the entry in the weighting table 104 is performed. In this case, in the transmitting of a data frame whose GD is the node G, a node that is different from the LD in the previous transmitting may be selected as an LD or the same node as the one that served as the LD in the previous transmitting may be selected again as an LD. When the process of step S220 ends, information indicating that a transfer destination has been “changed” or “not changed” is stored in the following step, step S402. The information is stored in the data frame manager 110. When the process of step S402 ends, the process shifts to step S228.

When the determination in step 218 indicates a judgment of No, the process shifts to step S222, where a new entry is registered in the weighting table 104. In this case, in the transmitting of a data frame whose GD is the node G, a new node to which data has never been transmitted from the node B becomes an LD. When the process of step S222 ends, information indicating that the transfer destination is “new” is stored in the following step, step S404. The information is stored in the data frame manager 110. When the process of step S404 ends, the process shifts to step S228.

When the determination in step S214 indicates a judgment of Yes, the process shifts to step S224. In this case, the data frame received at that time is data that was transmitted from the node B in the past. Hence, there is a possibility that a loop route has been formed.

In step S224, the weighting table 104 is searched using the value of the GD of the received data frame as a key. For this case, the value of the GD of the received data frame is registered in the weighting table 104, and hence the weight of the LD registered in the weighting table 104 is changed into the highest value in step S226. In addition, in this case, in the transmitting of a data frame whose GD is the node G, a node that is different from the LD in the previous transmitting serves as an LD. When the process of step S226 ends, information indicating that the transfer destination has been “changed” is stored in step S406. The information is stored in a data frame manager 1110. When the process of step S406 ends, the process shifts to step S228.

The processes of steps S216-S226 and S402-S406 are indicated by (3) in FIG. 16. That is, a value is read from the GD of the data frame, and the weighting table 104 is searched using the value as a key. Then, a search result is judged, and, in accordance with the result, data is registered in the weighting table 104, the weighting table 104 is updated, and it is recognized whether the transmission destination has been changed.

In step S228, with reference to the weighting table at that time, a transfer destination node, i.e., an LD, is determined and obtained.

In step S408, a process is performed of updating the loop sensing flag L of the received data frame. The process of step S408 is indicated by (4) in FIG. 16.

In the following step, step S230, a process is performed of updating the LD and the LS of the received data frame. In particular, the LD of the received data frame is changed from “B”, the ID of the node B, to “D”, the ID of the only node adjacent to the node B. The LS is changed from “A” to “B”. The processes of steps S228 and S230 are respectively indicated by (5) and (6) in FIG. 16.

In step S410, i.e., the step that follows step S230, a determination is made as to whether “0” is set as the loop sensing flag L of the received data frame, i.e., whether a setting has been made to skip a process for loop sensing. The process of this step is performed by the data frame manager 110 of the node apparatus.

When the determination in step S410 indicates a judgment of Yes, i.e., when the loop sensing flag L is “0”, and a setting has been made to skip the process for loop sensing, the process shifts to step S240.

When the determination in step S400 indicates a judgment of No, i.e., when the loop sensing flag L is “1”, and a setting has been made to perform the process for loop sensing, the process shifts to step S232.

In the following step, step S232, the FID management table 105 is searched using the GS and the FID of the received data frame as keys. In step S234, a determination is made as to whether an object is present that corresponds to an entry in the FID management table 105.

When the determination in step S234 indicates a judgment of Yes, the process of updating the FID management table 105 is performed in step S238, and the process then shifts to step S240. When the determination in step S234 indicates a judgment of No, a new registration process is performed for the FID management table 105 in step S236, and the process then shifts to step S240. The processes of steps S232-S238 are indicated as (7) in FIG. 16.

In step S240, a process is performed of transmitting the data frame. The process of step S240 is indicated as (8) in FIG. 16.

As described above, when the “loop sensing flag” is 0, the receiving process does not include judging loop sensing, and the transmitting process does not include the registration process for the “FID management table”. Hence, the load on the CPU resource of a node can be decreased and the memory can be effectively used, thereby improving transfer efficiency.

<Change of Route to Transfer Data Frame>

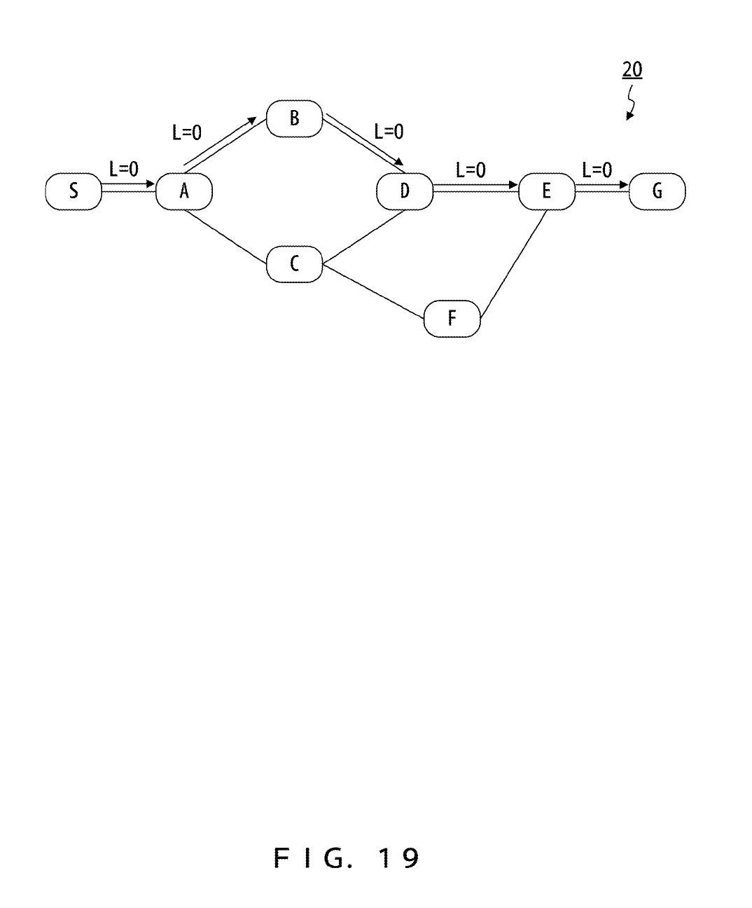

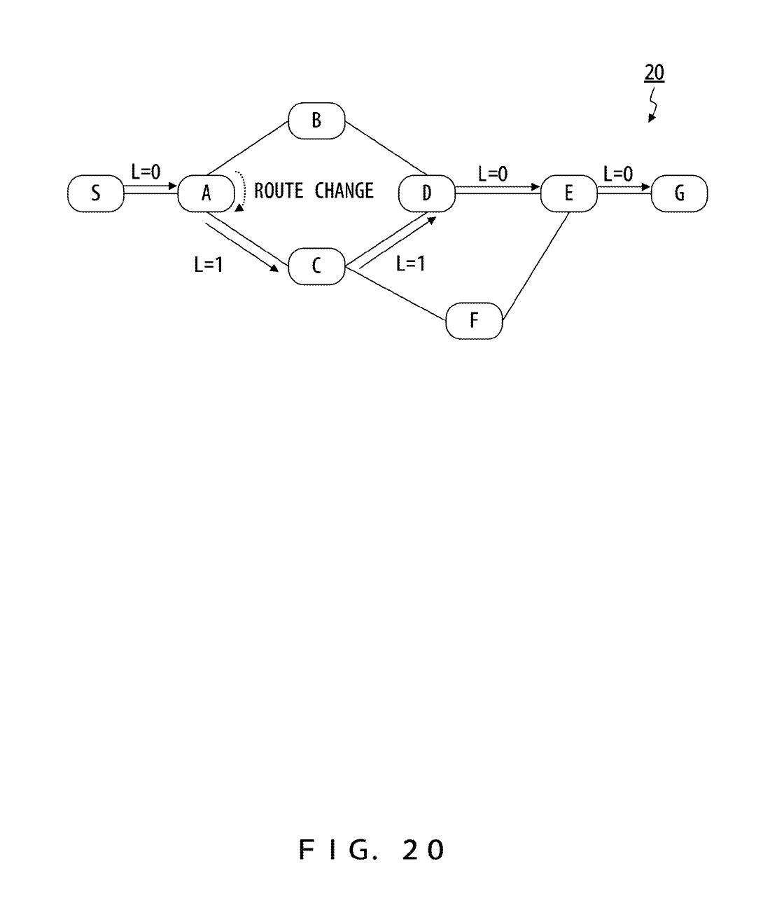

With reference to FIGS. 19 and 20, descriptions will be given of a change of a route to transfer a data frame.

A network 20 depicted in FIGS. 19 and 20 consists of nodes S, A, B, C, D, E, F, and G. The node S is adjacent to only the node A. The node A is adjacent to the nodes S, B, and C. That is, a link L_{SA} is present between the nodes S and A; a link L_{AB}, between the nodes A and B; a link L_{AC}, between the nodes A and C. The node B is adjacent to the nodes A and D, and the node C is adjacent to the nodes A, D, and F. That is, a link L_{BD} is present between the nodes B and D; a link L_{CD}, between the nodes C and D; a link L_{CF}, between the nodes C and F. The node F is adjacent to the node E in addition to the node C. That is, a link L_{EF} is present between the nodes F and E. The node D is adjacent to the node E in addition to the nodes B and C. That is, a link L_{DE} is present between the nodes D and E. The node G is adjacent to the node E only. That is, a link L_{EG} is present between the nodes E and G. As in the case of the aforementioned example, the links may be cable links or may be radio links. Alternatively, some of the links within the network 20 may be radio links and the others may be cable links.

In FIG. 19, the link L_{SA}, the link L_{AB}, the link L_{BD}, the link L_{DE}, and the link L_{EG} are stable. That is, a route <S, A, B, D, E, G> is a stable route. In this case, a data frame is transferred between the links under a condition in which the loop sensing flag L of the data frame is L=0, i.e., a loop sensing process is not performed.

FIG. 20 indicates the value of the loop sensing flag at each link in the situation depicted in FIG. 19 with the link L_{AB} being unstable for a certain reason.

The node A receives from the node S a data frame that has “0” as the value of a loop sensing flag L. Responsively, a transfer destination is decided on without a loop sensing process being performed. Assume that the node A selects the node B as a transfer destination.

The data frame transmitted from the node A to the node B does not reach the node B since the link L_{AB} is unstable. Accordingly, the node A selects the remaining adjacent node C as a transfer destination of the data frame. In accordance with the route change, the loop sensing flag L is changed into “1” and registered in the “FID management table”, and the data frame is then transferred to the node C.

Receiving the data frame that has “1” as the loop sensing flag L, the node C references the “FID management table” so as to perform a loop sensing process, and since the route is not a loop route, the node C references a “weighting table” for the node G, i.e., the GD, and selects the node D as an LD. The node C transfers the data frame to the node D after registering “1” as the loop sensing flag L in the “FID management table” because the node C has never transferred a data frame to the node G.

Receiving the data frame that has “1” as the loop sensing flag L, the node D references the “FID management table” so as to perform a loop sensing process, and since the route is not a loop route, the node D references the “weighting table” for the node G, i.e., the GD, and selects the node E as a transfer destination. The node D transfers the data frame to the node E after setting “0” as the loop sensing flag L without registration in the “FID management table” because the node D transmitted a data frame to the node G in the past and the route is stable.

In this example, the function of loop sensing works only for the portion of the node A directed to the transmitting process, for the receiving process and the transmitting process by the node C, and for the receiving process by the node D.

### Comparative Example

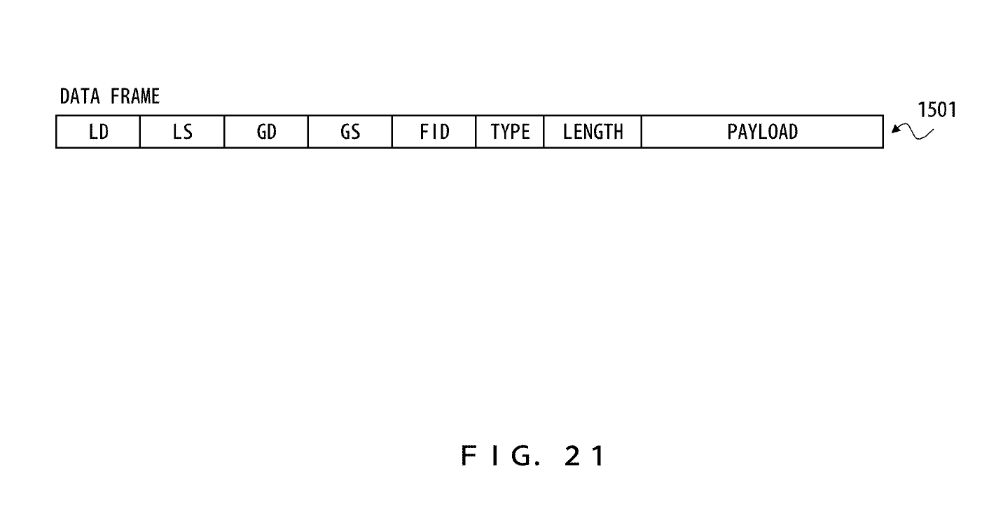

With reference to FIGS. 21-23, descriptions will be given of a comparative example relative to the aforementioned embodiments.

In the descriptions of this example, the same or similar reference marks are assigned to elements that have a function that is the same as or similar to a function of the networks of the aforementioned embodiments and to elements that have a function that is the same as or similar to a function of the elements of the node apparatuses that constitute the network, and such elements will not be described in detail. The same or similar reference marks are also assigned to processes that are performed at node apparatuses and that are the same as or similar to those in the aforementioned embodiments, and such processes will not be described in detail.

In the comparative example, a node apparatus that constitutes an ad-hoc network has a configuration that is similar to that of the node apparatus 100 described above. That is, a node apparatus 1100 in accordance with the present embodiment has a block diagram and a hardware configuration such as those in FIGS. 2 and 3, except for the process performed by the data frame manager 1110.

A data frame manager of the node apparatus of this example deals with a data frame 1501 that is different from the data frames in FIG. 8 in the sense that the data frame 1501 does not include a loop sensing flag field L.

FIG. 21 illustrates an exemplary configuration of the data frame 1501 used in the embodiment. The data frame 302 in this example includes a payload and a header that includes the fields LD, LS, GD, GS, FID, type, and length.

<Process after Reception of Data Frame>

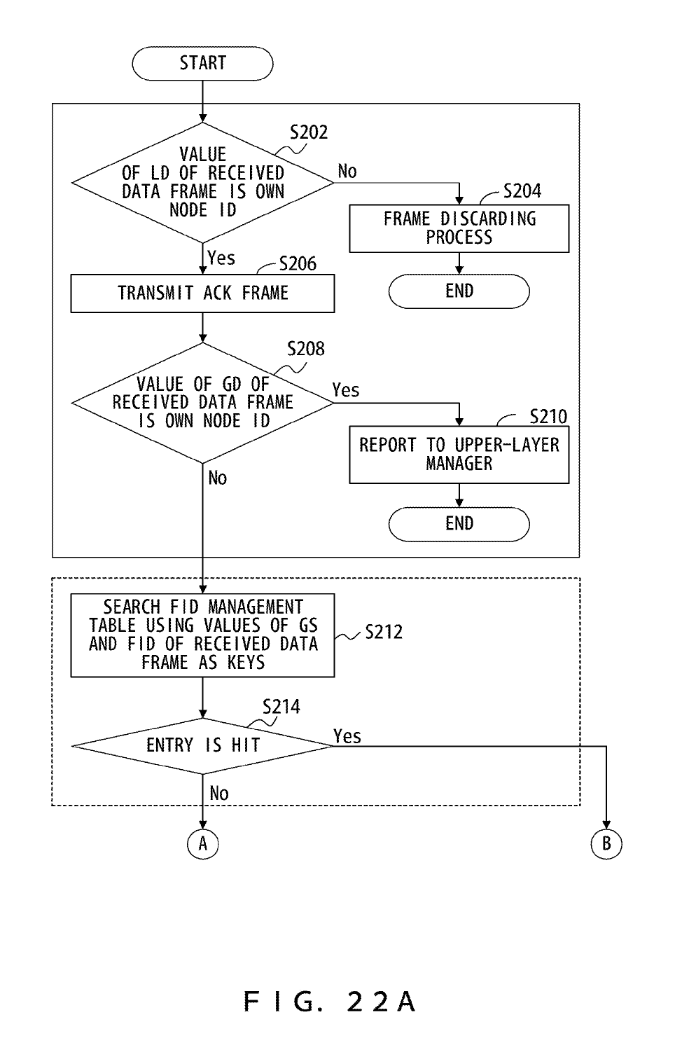

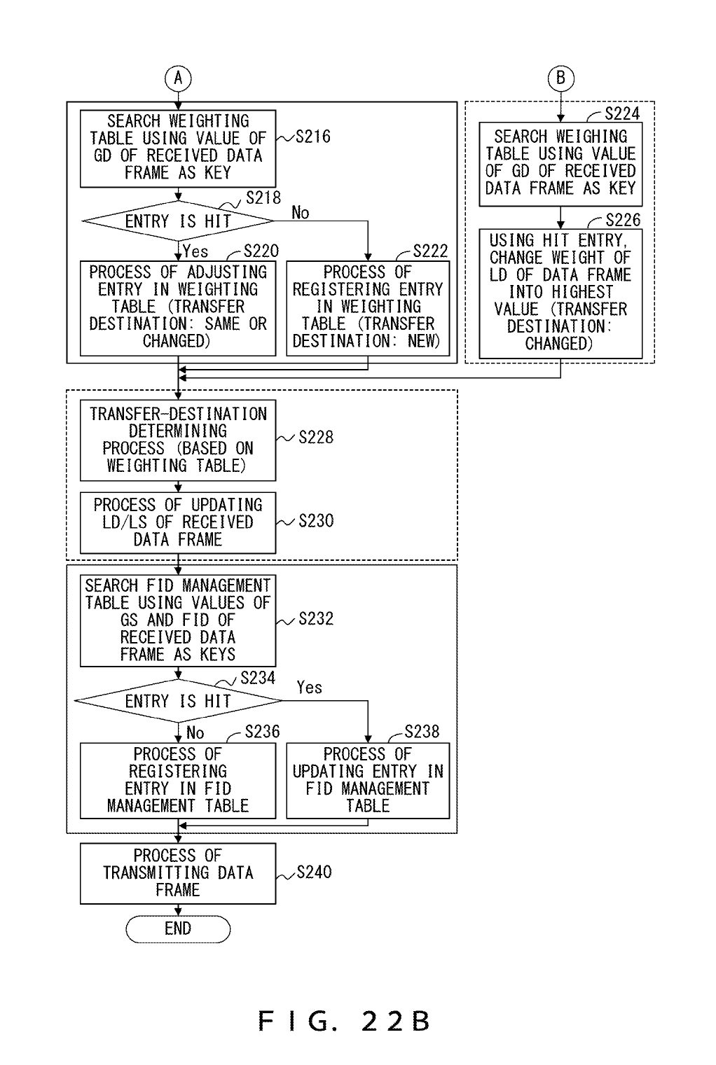

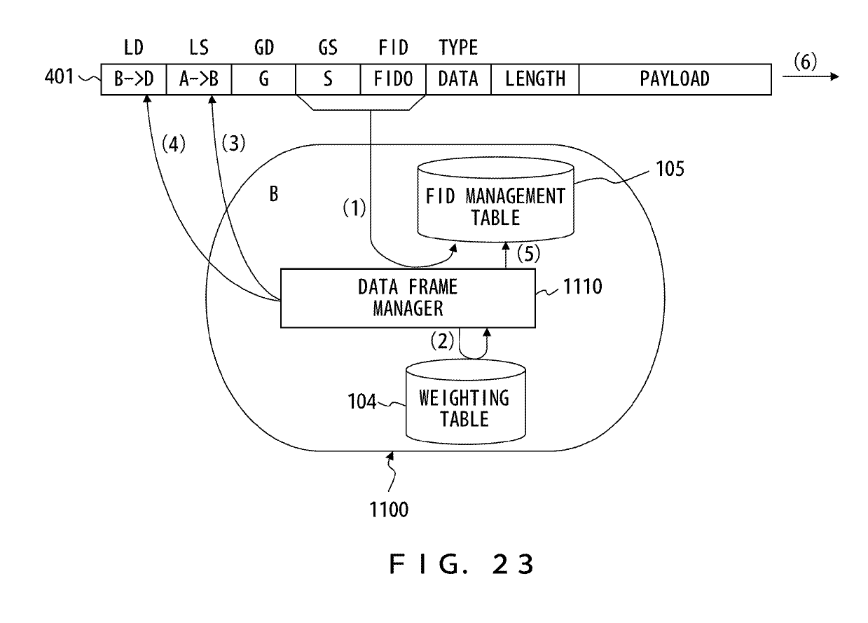

Next, with reference to FIGS. 22 and 23, descriptions will be given of a process of receiving a data frame. FIG. 22 are flowcharts illustrating a process performed after a data frame is received. FIG. 23 schematically illustrates a process performed at a node B.

The process after reception of a data frame starts with step S202. In step S202, a determination is made as to whether the value of the LD of the received data frame is the ID of the node itself. When the determination indicates a judgment of No, i.e., negative, the data frame is not to be received and is thus discarded in step S204.

When the determination in step S202 indicates a judgment of Yes, i.e., positive, the node B transmits an ACK frame to the transmission-source node A.

In the following step, step S208, a determination is made as to whether the value of the GD of the received data frame is the ID of the node itself. When the determination indicates a judgment of Yes, the process shifts to step S210, where this judgment is reported to the upper-layer manager 111. When the node apparatus is the GD, the upper-layer manager 111 processes a PDU of an upper layer included as a payload in the data frame.

When the determination in step S208 indicates a judgment of No, the process shifts to step S212.

In step S212, the FID management table 105 is searched according to the values of the GS and the FID of the received data frame.

In the following step, step S214, a determination is made as to whether the FID management table 105 includes an entry.

The processes of steps S214-S216 are indicated by (1) in FIG. 23. That is, values are read from the GS and the FID field of the data frame, and the FID management table 105 is searched using the values as keys. Then, a search result is judged.

When the determination in step S214 indicates a judgment of No, the process shifts to step S216. In step S216, the weighting table 104 is searched using the value of the GD of the received data frame as a key.

In step 218, a determination is made as to whether the value of the GD of the data frame hits an entry in the weighting table 104.

When the determination in step S218 indicates a judgment of Yes, the process shifts to step S220, where a process of adjusting the entry in the weighting table 104 is performed. In this case, in the transmitting of a data frame that indicates the node G as a GD, a node that is different from the LD in the previous transmitting may be selected as an LD or the same node as the one that served as the LD in the previous transmitting may be selected again as an LD. When the process of step S220 ends, the process shifts to step S228.

When the determination in step 218 indicates a judgment of No, the process shifts to step S222, where a new entry is registered in the weighting table 104. In this case, in the transmitting of a data frame whose GD is the node G, a new node to which data has never been transmitted from the node B becomes an LD. When the process of step S222 ends, the process shifts to step S228.

When the determination in step S214 indicates a judgment of Yes, the process shifts to step S224. In this case, the data frame received at that time is a data frame that was transmitted from the node B in the past. Hence, there is a possibility that a loop route has been formed.

In step S224, the weighting table 104 is searched using the value of the GD of the received data frame as a key. For this case, the value of the GD of the received data frame has been registered in the weighting table 104, and hence the weight of the LD registered in the weighting table 104 is changed into the highest value in step S226. In addition, in this case, in the transmitting of a data frame whose GD is the node G, anode that is different from the LD in the previous transmitting serves as an LD. When the process of step S226 ends, the process shifts to step S228.

The processes of steps S216-S226 and S402-S406 are indicated by (2) in FIG. 23. That is, a value is read from the GD of the data frame, and the weighting table 104 is searched using the value as a key. Then, a search result is judged, and, in accordance with the result, data is registered in the weighting table 104, and the weighting table 104 is updated.

In step S228, with reference to the weighting table at that time, a transfer destination node, i.e., an LD, is determined.

In step S230, a process is performed of updating the LD and the LS of the received data frame. In particular, the LD of the received data frame is changed from “B”, the ID of the node B, to “D”, the ID of the only node adjacent to the node B. The LS is changed from “A” to “B”. The processes of steps S228-S230 are indicated by (3) and (4) in FIG. 23.

In step S232, a step that follows step S230, the FID management table 105 is searched using the GS and the FID of the received data frame as keys. In step S234, a determination is made as to whether a corresponding entry is present in the FID management table 105.

When the determination in step S234 indicates a judgment of Yes, the process of updating the FID management table 105 is performed in step S238, and the process then shifts to step S240. When the determination in step S234 indicates a judgment of No, a new registration process is performed for the FID management table 105 in step S236, and the process then shifts to step S240. The processes of steps S232-S238 are indicated by (5) in FIG. 23.

In step S240, the data frame is transmitted to the node D.

As described above, the process of receiving a data frame in this example lacks the processes of S400 and S410 in FIG. 18. Thus, regardless of whether a data frame is transferred through a stabilized route, each node always performs the loop-route sensing process.

In a network constituted by the aforementioned node apparatuses, a large data communication traffic volume has a great influence on the resources of the FID management table of a relay node and the CPU resources for the processing times of search, registration, and deletion of the FID management table; in addition, data throughput is affected when a hop count, which indicates the number of relay nodes that transfer data, is large.

<Operation/Working-Effect>

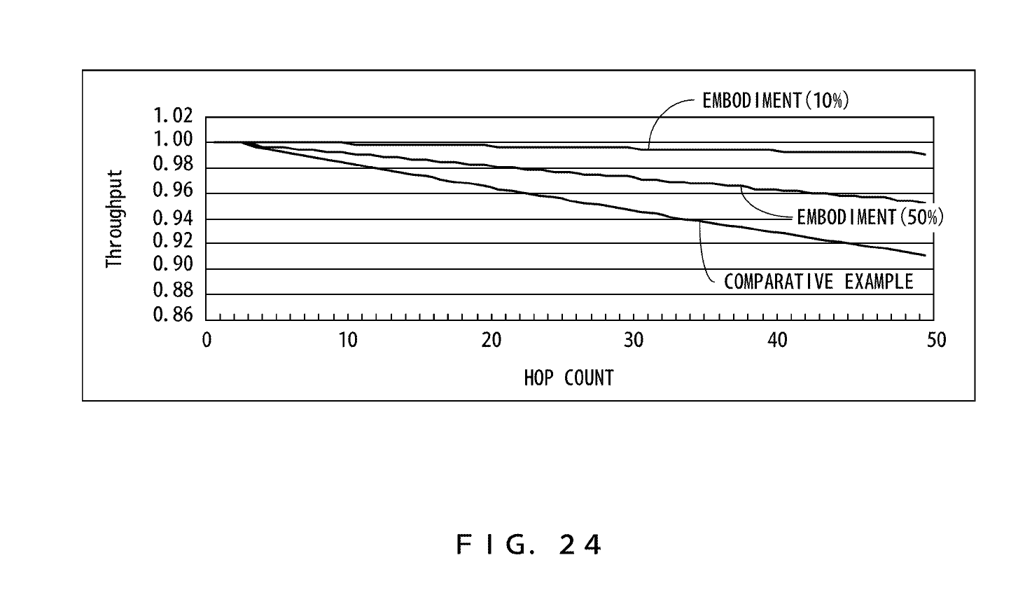

FIG. 24 is a graph indicating a comparison between the throughput provided by the use of the node apparatus in the embodiment and the throughput provided by the use of the node apparatus in the comparative example.

In FIG. 24, the vertical axis corresponds to throughput and the horizontal axis corresponds to hop count. The graph indicates that a larger number of nodes via which data is transferred lead to a longer elapsed time, which results in a lower throughput of the entire network.

In the figure, delayer the percentage of nodes that have transferred data whose loop sensing flag indicates “1”. That is, a percentage of 100% is similar to the percentage in the comparative example. The graph also indicates that a lower percentage of delay nodes or a higher hop count leads to a higher throughput.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A node apparatus comprising:
a receiver configured to receive a frame that includes a route stability indicator from one adjacent node apparatus of a plurality of node apparatuses that constitute a network;
a memory configured to store, in association with each other, frame identification information to identify the frame, transmission-destination-node identification information to identify an adjacent node apparatus from among the adjacent node apparatuses to which the frame is to be transferred, and origin-node identification information to identify a node apparatus that is a first to have transmitted the frame, and stores transmission possibility information indicating a possibility of transmission to each of the adjacent node apparatuses when an ultimate destination is given, the ultimate destination identifying a node apparatus from among the plurality of node apparatuses to which the frame is to be ultimately delivered;
a processor configured to determine, according to the route stability indicator of the frame, whether to perform a process of judging whether the frame identification information to identify the frame is stored in the memory as the frame identification information, makes an update the transmission possibility information stored in the memory such that the possibility of transmission to the node apparatus identified by the transmission-destination-node identification information indicates “not transmittable” only when the process of judging whether the frame identification information to identify the frame is stored in the first storage as the frame identification information is to be performed and the frame identification information to identify the frame is stored in the first storage as the frame identification information, and selects, as a transmission-destination node apparatus, one adjacent node apparatus from the plurality of node apparatuses according to the transmission possibility information stored in the memory in association with the ultimate destination of the frame; and
a transmitter configured to transmit the frame to the transmission-destination node apparatus.

2. The node apparatus according to claim 1, wherein
the processor further measures off a time that has elapsed after a frame was transmitted to the transfer-destination node apparatus, and
the transmitter transmits the frame after the processor changes the route stability indicator so as to perform the process of judging whether the frame identification information to identify the frame is stored in the first storage as the frame identification information.

3. The node apparatus according to claim 1, wherein
the processor further obtains information related to a route to the ultimate destination of the received frame, wherein
the transmission possibility information stored by the memory includes the information related to the route to the ultimate destination of the frame, and
when the information related to the route to the ultimate destination of the frame changes, the transmitter transmits the frame after changing the route stability indicator so as to perform the process of judging whether the frame identification information to identify the frame is stored in the first storage as the frame identification information.

4. The node apparatus according to claim 3, wherein
the information related to the route to the ultimate destination of the frame is a hop count.

5. The node apparatus according to claim 3, wherein
the information related to the route to the ultimate destination of the frame is information related to a quality of the route.

6. The node apparatus according to claim 1, wherein
in the transmitting of the frame to the transmission-destination node apparatus, under a condition in which the processor changed the possibility of transmission to the transmission-destination node apparatus in the previous transmitting, the transmitter transmits the frame after changing the route stability indicator so as to perform the process of judging whether the frame identification information to identify the frame is stored in the memory as the frame identification information.

7. The node apparatus according to claim 1, wherein
in the transmitting of the frame to the transmission-destination node apparatus, under a condition in which the transmission-destination node is anode apparatus designated by the ultimate destination, the transmitter transmits the frame after changing the route stability indicator so as to not perform the process of judging whether the frame identification information to identify the frame is stored in the memory as the frame identification information.

8. A data transfer method, comprising:
receiving a frame that includes a route stability indicator from one adjacent node apparatus of a plurality of node apparatuses that constitute a network by a receiver;
associating, with each other, frame identification information to identify the frame, transmission-destination-node identification information to identify one adjacent node apparatus from among the adjacent node apparatuses to which the frame is to be transferred, and origin-node identification information to identify a node apparatus that is a first to have transmitted the frame by a processor;
obtaining transmission possibility information indicating a possibility of transmission to each of the adjacent node apparatuses when an ultimate destination is given, the ultimate destination identifying one node apparatus from among the plurality of node apparatuses to which the frame is to be ultimately delivered by the processor;
determining, according to the route stability indicator of the frame, whether to perform a process of judging whether the frame identification information to identify the frame is stored in a memory as the frame identification information by the processor;
making an update the transmission possibility information stored in the memory such that the possibility of transmission to the node apparatus identified by the transmission-destination-node identification information indicates “not transmittable” only when the process of judging whether the frame identification information to identify the frame is stored in the memory as the frame identification information is to be performed and the frame identification information to identify the frame is stored in the memory as the frame identification information by the processor;
selecting, as a transmission-destination node apparatus, one adjacent node apparatus from the plurality of node apparatuses according to the transmission possibility information stored in the memory in association with the ultimate destination of the frame by the processor; and
transmitting the frame to the transmission-destination node apparatus by a transmitter.

9. The data transfer method according to claim 8, further comprising:
measuring off a time that has elapsed after a frame was transmitted to the transfer-destination node apparatus by the processor, wherein
the transmitting includes transmitting the frame after changing the route stability indicator so as to perform the process of judging whether the frame identification information to identify the frame is stored as the frame identification information by a transmitter.

10. The data transfer method according to claim 8, further comprising:
obtaining information related to a route to the ultimate destination of the frame by the processor, wherein
the transmission possibility information includes the information related to the route to the ultimate destination of the frame, and
when the information related to the route to the ultimate destination of the frame changes, the transmitter transmits the frame after changing the route stability indicator so as to perform the process of judging whether the frame identification information to identify the frame is stored as the frame identification information.

11. The data transfer method according to claim 10, wherein
the information related to the route to the ultimate destination of the frame is a hop count.

12. The data transfer method according to claim 10, wherein
the information related to the route to the ultimate destination of the frame is information related to a quality of the route.

13. The data transfer method according to claim 8, wherein
in the transmitting of the frame to the transmission-destination node apparatus, under a condition in which the processor changed the possibility of transmission to the transmission-destination node apparatus in the previous transmitting, the frame after changing the route stability indicator is transmitted by a transmitter so as to perform the process of judging whether the frame identification information to identify the frame is stored in the memory as the frame identification information.

14. The data transfer method according to claim 8, wherein
in the transmitting of the frame to the transmission-destination node apparatus, under a condition in which the transmission-destination node is anode apparatus designated by the ultimate destination, the transmitter transmits the frame after changing the route stability indicator so as to not perform the process of judging whether the frame identification information to identify the frame is stored in the memory as the frame identification information.
